(19) United States
(12) Patent Application Publication
(10) Pub. No.: US 2025/0309724 A1
(43) Pub. Date: Oct. 2, 2025

(54) LEAD FRAME FOR ELECTRICAL CONTACT OF A STATOR

(71) Applicant: BorgWarner Inc., Auburn Hills, MI (US)

(72) Inventors: Andre Mayer, Bann (DE); Thomas Glass, Rockenhausen (DE)

(21) Appl. No.: 19/089,512

(22) Filed: Mar. 25, 2025

(30) Foreign Application Priority Data
Mar. 26, 2024 (DE) 10 2024 108 663.7

(51) Int. Cl. H02K 3/52; H02K 15/32

(52) U.S. Cl. CPC H02K 3/522; H02K 15/32; H02K 2203/09

(57) ABSTRACT

The present application relates to a lead frame for making electrical contact with stator windings of a three-phase stator. The lead frame comprises an annular main body, three connection contacts, a plurality of line planes and a plurality of electrically conductive contact elements. The annular main body has an upper side and a lower side. The three connection contacts are designed to make electrical contact between a respective stator phase and an inverter on the inverter side. The plurality of line planes are arranged in an axially insulated manner in the annular main body. The line planes have a plurality of line sections spaced apart in the circumferential direction. The plurality of electrically conductive contact elements extend axially through the annular main body. Furthermore, the contact elements are arranged so as to be distributed in the circumferential direction. In addition, the contact elements are arranged in a manner radially spaced apart from the line sections. The line planes also have line tabs which radially protrude from the line sections and electrically connect the line sections to the contact elements. The line tabs are arranged in such a way that an electrical interconnection of the stator phases between the contact elements and the connection contacts is provided by the line planes and the contact elements. Furthermore, at least some of the plurality of contact elements are designed to make electrical contact with the stator windings.

### TECHNICAL FIELD

The present disclosure relates to a lead frame for making electrical contact with stator windings. In particular, the present disclosure relates to a stator arrangement for an electrical machine having such a lead frame, and to an electrical machine having such a stator arrangement. In addition, the present disclosure relates to a method for producing a stator arrangement for an electrical machine.

### BACKGROUND

Electrical machines have always been used in many technical fields for the conversion of electrical energy into kinetic energy and/or for the conversion of kinetic energy into electrical energy. An electrical machine is an electrical device that can convert electrical energy into mechanical energy (also called an electric motor or e-motor). The mechanical energy can be used in turn to generate kinetic energy that can be used to drive other devices. If mechanical or kinetic energy is converted into electrical energy, the electrical machine can also be referred to as a generator. Electrical machines can often be operated in both a motor function and a generator function. An electric motor generally comprises a stator and a rotor spaced apart from it, which are accommodated in a motor housing. The stator is fixed in position. The rotor moves relative to the stator and usually sits on a drive shaft that rotates together with the rotor. The shaft can be used to transfer the rotational energy to other devices.

Most electric motors generate energy with a magnetic field and a winding current. For this purpose, known stators comprise a plurality of circumferentially distributed stator teeth which extend in the direction of the rotor and form an annular stator. Each stator tooth is wrapped in a metal, highly conductive material, such as a winding wire. Thus, each wrapped stator tooth forms a stator winding. The rotor usually consists of a rotor body which is connected to the drive shaft and on which circumferentially distributed permanent magnets are arranged, which are arranged so as to be adjacent to and spaced apart from the stator teeth. When current is applied to the stator windings, a magnetic field is generated and acts on the permanent magnets of the rotor with a torque that can be used to drive the rotor.

In particular, it is known to use a multi-phase, for example a three-phase, power supply, wherein the phases of the power supply are at least partially temporally offset, for example offset sinusoidal signals. Accordingly, a stator can be referred to as a multi-phase or three-phase stator. Depending on the desired circuit, for example, one of the phases is assigned to each stator winding and current of the assigned phase is accordingly applied to it. It is further known to arrange stator windings of a respective phase individually or to arrange a plurality of stator windings beside one another in phase groups (for example two, three or four stator windings in a phase group). For example, a stator winding of the first phase, a stator winding of the second phase and then a stator winding of the third phase can be arranged successively in the circumferential direction (depending on the number of stator windings, then further in the circumferential direction following this pattern). If stator phases are arranged in phase groups, for example, two stator windings of the first phase, then two stator windings of the second phase and then two stator windings of the third phase can be arranged successively in the circumferential direction. If a stator comprises, for example, eighteen stator teeth or eighteen stator windings, the arrangement pattern just described can follow twice more in succession in the circumferential direction. Then, such a stator would contain three phase groups of a respective stator phase, each phase group containing two stator windings of a respective phase. Furthermore, it is known to wind each stator tooth with a separate winding wire or to use a single wire for a plurality of stator teeth of the same phase, in particular for stator teeth or stator windings of a phase group. If a plurality of stator teeth of the same phase, in particular stator teeth or stator windings of a phase group, are wound with a single or common wire, it is also possible to refer to a winding group.

The wire ends of the stator windings must be electrically connected to or in contact with the power supply for their respective phase and must be interconnected accordingly. For this electrical interconnection of the stator phases or electrical contact of the stator windings, the stator windings are usually in electrical contact with a so-called lead frame. A lead frame typically comprises copper strips for interconnecting the phases, which are arranged so as to be electrically insulated from each other in a plastic housing. The wire ends of the stator windings are usually connected to the lead frame by welding, hot crimping or soldering. The stator phases are connected to a control unit (e.g. inverter) via the lead frame.

The object of the present invention is to provide an apparatus for making electrical contact with and interconnecting the stator windings which is improved with regard to efficiency, production effort and installation space.

### SUMMARY OF THE INVENTION

The present disclosure relates to a lead frame for making electrical contact with stator windings as claimed in claim 1. In particular, the present disclosure relates to a stator arrangement for an electrical machine as claimed in claim 11, and to an electrical machine having a corresponding stator arrangement as claimed in claim 14. Furthermore, the present disclosure relates to a method for producing a stator arrangement for an electrical machine as claimed in claim 15.

According to a first aspect according to the invention, a lead frame for making electrical contact with stator windings of a three-phase stator is disclosed. The lead frame comprises an annular main body, three connection contacts, a plurality of line planes and a plurality of electrically conductive contact elements. The annular main body has an upper side and a lower side. The three connection contacts are designed to make electrical contact between a respective stator phase and an inverter on the inverter side. The plurality of line planes are arranged in an axially insulated manner in the annular main body. The line planes have a plurality of line sections spaced apart in the circumferential direction. The plurality of electrically conductive contact elements extend axially through the annular main body. Furthermore, the contact elements are arranged so as to be distributed in the circumferential direction. In addition, the contact elements are arranged in a manner radially spaced apart from the line sections. The line planes also have line tabs which radially protrude from the line sections and electrically connect the line sections to the contact elements. The line tabs are arranged in such a way that an electrical interconnection of the stator phases between the contact elements and the connection contacts is provided by the line planes and the contact elements. Furthermore, at least some of the plurality of contact elements are designed to make electrical contact with the stator windings. Line sections of different line planes can be electrically connected to each other by means of line tabs and contact elements. Thus, the contact elements can serve as a type of plane contact-making means or throughplating means between different line planes having a line tab in the area of the same contact element. In addition, the at least some contact elements, which are designed to make electrical contact with the stator windings, make it possible on the one hand to connect a stator winding to the contact element and on the other hand to use this contact element to electrically connect one or more line sections electrically connected thereto to the stator winding.

In configurations of the lead frame, the at least some of the plurality of contact elements may have an opening on the lower side for making electrical contact with the stator windings. In particular, the openings may be configured such that the lead frame can be mounted on electrical ends of the stator. In other words, at least one recess in the contact element is formed by the opening, into which electrical ends of the stator (for example wire ends or electrical connectors connected thereto) can be inserted when assembling the lead frame with the stator. For example, the lead frame can be mounted or plugged onto the electrical ends. As a result of the fact that the contact element is made of an electrically conductive material, the lead frame can therefore be mounted on the stator and electrical contact can be made with the stator in a simple manner. In particular, in configurations of stators in which a plurality of stator teeth are wound with a single winding wire, only at least some of the plurality of contact elements may be formed with an opening. For example, adjacent stator teeth in winding groups of two or three (or more) stator teeth may be wound with a single winding wire. In such an example, it would be necessary to make contact between the winding group with the two, three (or more) wound stator teeth and the lead frame only via two wire ends. Consequently, only every fourth (in the case of two stator windings in a winding group with a common winding wire) or every sixth (in the case of three stator windings in a winding group with a common winding wire) contact element could be formed with an opening on the lower side. In configurations, in particular, all contact elements can also be formed in the same way. For example, all contact elements may have openings on the lower side. The electrical ends of the stator can be understood as meaning those line ends that are in electrical contact with the lead frame. For example, these can be wire ends of the winding wire or electrical connectors. The electrical connectors can be electrically connected to the wire ends. When mounted, the electrical connectors may be arranged between the wire ends and the lead frame. Especially in the case of electrical connectors, the lead frame can be pressed onto the electrical ends.

In configurations of the lead frame, the at least some of the plurality of contact elements may have a passage extending from the opening to the upper side. The passage can provide space for the electrical ends, in particular for electrical connectors, which can be inserted, in particular can be pressed, into the contact elements or their passages. Providing a press-in option for the electrical ends makes it possible to make contact with and assemble the line arrangement and the stator in a considerably simpler manner, for example, compared to making contact by welding. In advantageous configurations, the passage can be designed to taper toward the upper side. In configurations, the taper may be conical or bent, for example. The taper can improve holding of the electrical ends and/or a fit of the lead frame on the electrical ends. In addition, the taper can improve positioning of the lead frame on the stator during the mounting process.

In configurations of the lead frame, the at least some of the plurality of contact elements may be designed to press in electrical connectors of the stator windings of the stator. In particular, the at least some of the plurality of contact elements may be designed such that the lead frame can be pressed onto the electrical connectors.

In configurations of the lead frame, the at least some of the plurality of contact elements may be provided in a number of wire ends which are present in the stator with which contact is to be made. In some configurations, the number of the plurality of contact elements can correspond to the number of wire ends which are present in the stator with which contact is to be made.

In configurations of the lead frame, the at least some of the plurality of contact elements may be provided in a number of 6 to 72. In particular, the at least some of the plurality of contact elements can be provided in a number of 12 to 36.

In configurations of the lead frame, the plurality of contact elements may be provided in a number of 6 to 72. In particular, the plurality of contact elements can be provided in a number of 12 to 36.

In configurations of the lead frame, the contact elements can be arranged at positions distributed in the circumferential direction. The positions are assigned to areas of stator windings of a respective stator phase. In configurations, the line tabs can be arranged only at those positions in a respective line plane which are required for the electrical interconnection of the stator phases of the line section connected to the line tab.

In configurations of the lead frame, the contact elements can be arranged radially inside and/or radially outside the line sections.

In configurations of the lead frame, the contact elements may be arranged so as to be spaced apart from an inner circumference of the annular main body and/or from an outer circumference of the annular main body.

In configurations of the lead frame, a radial width of the annular main body between an inner diameter of the annular main body and an outer diameter of the annular main body can be 20 mm or more. Preferably, the radial width of the annular main body can be 30 mm or more. Particularly preferably, the radial width of the annular main body can be 40 mm or more. In configurations, the radial width of the annular main body can be between 20 mm and 80 mm, preferably between 30 mm and 60 mm, and particularly preferably between 25 mm and 45 mm. In configurations, the radial width of the annular main body may correspond substantially to a radial width of the stator between its inner circumference and outer circumference. For example, this may include radial widths of 75% to 125% of the radial width of the stator. In configurations, an inner diameter on the inner circumference of the annular main body may be, for example, 50 mm to 500 mm, preferably 100 mm to 250 mm, and particularly preferably 125 mm to 200 mm.

In configurations of the lead frame, the line sections can extend at least in sections in the radial direction at least over 40% of a radial width of the annular main body between an inner diameter of the annular main body and an outer diameter of the annular main body. Preferably, the line sections can extend at least over 50% of a radial width of the annular main body. Particularly preferably, the line sections can extend at least over 60% of a radial width of the annular main body. Such a designed radial width of a line section makes it possible to use an available total width (i.e. the radial width of the annular main body) to a greater extent compared to, for example, conventionally used copper strips. In other words, in order to achieve a sufficient line cross section, which is necessary for the current flow, an axial thickness of the line sections can be significantly reduced by this flat design of the line sections in comparison with a conventional lead frame.

In configurations of the lead frame, an axial thickness of the line planes may be smaller than a radial width of the line planes at least by a factor of 50. Preferably, the axial thickness of the line planes can be smaller than the radial width of the line planes at least by a factor of 100. Particularly preferably, the axial thickness of the line planes can be smaller than the radial width of the line planes at least by a factor of 200. Such a designed axial thickness of a line plane makes it possible to reduce an axial total thickness of the annular main body between the upper side and the lower side. Overall, it is thus possible to reduce the required installation space in the axial direction.

In configurations of the lead frame, an axial thickness of the line planes may be 200 μm or less, preferably 150 μm or less, and particularly preferably 125 μm or less. In configurations, the axial thickness may be at least 50 μm or at least 75 μm. In configurations, the axial thickness may be 50 μm to 150 μm, preferably 70 μm to 130 μm, and particularly preferably 80 μm to 120 μm. Such a designed axial thickness of a line plane makes it possible to greatly reduce axial installation space compared to copper strips conventionally used in lead frames.

In configurations of the lead frame, an axial thickness of the annular main body may be 1 mm to 3 mm, preferably 1.2 mm to 2 mm, and particularly preferably 1.4 mm to 1.8 mm. Such an axial thickness of the annular main body between the upper side and the lower side makes it possible to reduce installation space required in the axial direction.

In configurations of the lead frame, the annular main body may have a multi-layer printed circuit board structure.

In configurations of the lead frame, the line planes can be embedded in a substrate. In configurations, the line planes can be electrically insulated from each other by a substrate, in particular electrically insulated from each other. In particular, the line sections of a line plane can be electrically insulated from each other in the circumferential direction by a substrate. In particular, the line tabs may be connected to the line sections in an electrically conductive manner. In particular, a line tab can be assigned to only a single line section.

In configurations of the lead frame, at least three line planes, in particular at least six line planes, may be arranged in the annular main body.

In configurations of the lead frame, one of the plurality of line planes may have at least two, preferably at least three, and particularly preferably at least four, line sections that are spaced apart from each other. In particular, the line sections of a line plane can be spaced apart from each other in the circumferential direction. In particular, each line plane can have at least two, preferably at least three, and particularly preferably at least four, line sections spaced apart from each other in the circumferential direction.

In configurations of the lead frame, the line sections can extend in the circumferential direction. In particular, the line sections can extend in a band-like manner in the circumferential direction.

In configurations of the lead frame, each line section can be connected to at least one line tab.

In configurations of the lead frame, the line tabs can surround the contact elements in the radial direction and/or in the circumferential direction. In particular, the line tabs can completely surround the contact elements in the radial direction and in the circumferential direction.

In configurations of the lead frame, the line planes can be configured such that a star circuit or a delta circuit of the stator phases is provided.

In configurations of the lead frame, the connection contacts can be electrically connected to at least one line plane directly and/or via at least one conductor pin arrangement. In particular, the connection contacts may be electrically connected to a line section and/or a line tab in at least one line plane. The conductor pin arrangement may be electrically conductive. The conductor pin arrangement may extend in the axial direction. In configurations, the conductor pin arrangement may comprise at least one or more conductor pins.

In configurations of the lead frame, the annular main body may comprise a radial bulge on which the connection contacts are arranged. In particular, the bulge can protrude radially outward over the outer circumference.

In configurations of the lead frame, the lead frame may further comprise a connection apparatus. The connection apparatus is electrically connected to the connection contacts for making electrical contact between a respective stator phase and the inverter. In configurations, the connection apparatus may be arranged on the upper side of the annular main body. In configurations, the connection apparatus can be arranged axially above the connection contacts. In configurations of the lead frame, the connection apparatus can be fastened to the annular main body in a floating manner. This makes it possible to compensate for tolerances when mounting the lead frame in a stator housing. In configurations, the connection apparatus can be fastened to the annular main body via a clip connection. For example, one or more clip arms can grip the lower side of the annular main body.

In configurations of the lead frame, the connection apparatus may comprise a housing, three main line pins and three cables for electrical connection between the main line pins and the connection contacts. The main line pins can be fastened in the housing. In configurations, the main line pins may be surrounded at least partially by a two-component encapsulation. The two-component encapsulation can form a section of the housing or the entire housing of the connection apparatus. The two-component encapsulation makes it possible to save sealing elements that are otherwise additionally required. In particular, the main line pins can protrude in the axial direction from the housing (preferably in the direction away from the annular main body). In some configurations, the cables can be ultrasonically welded to the connection contacts.

According to a second aspect according to the invention, a stator arrangement for an electrical machine is disclosed. The stator arrangement comprises a stator and a lead frame according to the first aspect. The stator comprises a plurality of stator teeth wound with winding wire in order to form a stator winding on a stator tooth. The lead frame is arranged at an axial end of the stator and is electrically connected to electrical ends of the stator for interconnecting the stator phases. In particular, the lead frame can be electrically connected to wire ends of the winding wire for interconnecting the stator phases. In configurations, the lead frame can be electrically connected to the wire ends directly or can be electrically connected to the wire ends via electrical connectors. In other words, the expression “electrically connected” to wire ends may include both a direct contact connection and an electrical connection implemented via an electrical connector. The stator arrangement with the lead frame can simplify mounting and/or production. In addition, especially when using a plug connection, the risk of contamination during production, such as in the case of alternative welding methods, can be eliminated or at least reduced. Furthermore, an axial (relative to an axis of the stator) thickness of the stator arrangement can be reduced by the line-plane structure.

In configurations of the stator arrangement, the stator teeth can be wound with a winding wire individually or in winding groups of the same stator phase.

In configurations of the stator arrangement, the stator arrangement may further comprise a plurality of electrical connectors. A respective wire end of the winding wire can be electrically connected to the lead frame via one of the plurality of electrical connectors. In configurations, the lead frame can be plugged, in particular pressed, onto the electrical connectors for making electrical contact with the stator windings. In particular, the lead frame can be plugged, in particular pressed, onto the electrical connectors via the contact elements. In configurations, the electrical connectors may have a press-in section which is connected to the contact elements. In particular, in configurations in which the at least some contact elements have openings on the lower side, a respective press-in section may be pressed into the opening of a contact element. In configurations, the electrical connectors can be in the form of insulation displacement connectors having an insulation displacement section, wherein a respective insulation displacement section is plugged onto a respective wire end. In configurations, the press-in section and the insulation displacement section may be formed at axially opposite end areas of the electrical connector. Plugging the insulation displacement section onto the winding wire or its ends makes it possible to achieve contact or electrical connection between the electrical connector and the respective wire end by means of a cold welding process. This in turn makes it possible to achieve electrical contact or interconnection of the stator windings or stator phases by simply connecting the lead frame to the electrical connectors.

In configurations of the stator arrangement, the stator may further comprise a plurality of receiving sections. The receiving sections are configured to receive the wire ends and to receive electrical connectors. In particular, the receiving sections may be configured such that, by receiving the electrical connectors, the wire ends received in the receiving section are electrically connected to the electrical connector. The stator phases can then be electrically interconnected by simply making contact between the electrical connectors and the lead frame. In configurations, the receiving sections may comprise a respective wire end receiving area which is configured to receive a respective wire end. In particular, the wire ends can be arranged at least partially in a respective wire end receiving area. In configurations, the receiving sections may comprise a respective connector receiving area which is configured to receive a respective electrical connector. In particular, the electrical connectors can be arranged at least partially in a respective connector receiving area. In configurations comprising a wire end receiving area and a connector receiving area, the wire end receiving area and the connector receiving area may be arranged so as to intersect each other, so that, when an electrical connector is inserted into a connector receiving area, a wire end arranged in the wire end receiving area is cut by the electrical connector with electrical contact.

In configurations of the stator arrangement which comprise a plurality of electrical connectors and a plurality of receiving sections, the electrical connectors may each be arranged in a receiving section such that a press-in section of an electrical connector projects from the receiving section and is connected to the line arrangement. In configurations, the press-in section of a connector may be connected to a contact element of the lead frame, in particular may be pressed into a respective contact element.

In some configurations of the stator arrangement which comprise a plurality of receiving sections, the receiving sections may comprise a respective lead frame receiving area which is configured to support the lead frame.

In some configurations of the stator arrangement which comprise a plurality of receiving sections, the receiving sections may be integrated in a stator end cap of the stator.

In configurations of the stator arrangement, the stator arrangement may further comprise a potting body and a stator housing. The stator housing can define an annular receiving area with a circumferential section and an annular end wall. The stator may be arranged with the lead frame in the receiving area such that the lead frame is arranged adjacent to the annular end wall. In configurations, the stator may be potted with the lead frame in the receiving area. The potting body arranged between the stator housing and the stator with the lead frame makes it possible to at least partially embed the stator with the lead frame in the potting body. In configurations, the stator housing may further comprise a passage in the annular end wall. A connection apparatus (50) of the lead frame can at least partially project through the passage to the outside of the stator housing.

According to a third aspect according to the invention, an electrical machine is disclosed. In particular, the electrical machine can be an electric motor. The electrical machine comprises a machine housing, a shaft, at least one rotor, an inverter and a stator arrangement according to the second aspect. The shaft is mounted rotatably in the machine housing. The rotor is arranged for conjoint rotation on the shaft in the machine housing. The stator is arranged adjacent to the rotor in the machine housing. The inverter is designed to control the stator. Furthermore, the inverter is electrically connected to the lead frame.

In configurations of the electrical machine, the inverter can be electrically connected to the lead frame via a connection apparatus.

In configurations of the electrical machine, the stator may be arranged radially adjacent to the rotor in the machine housing. In configurations, the rotor may comprise a plurality of rotor poles which are arranged so as to be distributed in the circumferential direction on a rotor body of the rotor. In particular, the rotor poles can be in the form of permanent magnets. In configurations, the rotor may be formed externally and may surround the stator at least partially radially on the outside.

In configurations of the electrical machine, the machine housing may comprise a rotor housing and a stator housing. The rotor housing and the stator housing may be connected to each other in a force-fitting manner.

According to a fourth aspect according to the invention, a method for producing a stator arrangement for an electrical machine is disclosed. The method comprises providing a stator having a plurality of stator teeth. The stator teeth are wound with stator windings having electrical ends. The method also comprises providing a lead frame according to the first aspect. In addition, the method comprises making contact with the stator windings by making contact between electrical ends of the stator windings and the contact elements of the lead frame.

In configurations of the method, an electrical connector can be clamped onto a respective wire end of the stator windings in order to form electrical ends of the stator. In configurations, the wire ends of the stator windings can be pressed into an insulation displacement section of a respective electrical connector.

In configurations of the method, the electrical ends can be provided by inserting wire ends into a wire end receiving area of the stator and inserting an electrical connector into a connector receiving area of the stator, wherein an insulation displacement section of the electrical connector makes electrical contact with the respective wire end.

In configurations of the method, making contact with electrical ends may comprise mounting the lead frame on the stator. In configurations, making contact with electrical ends may comprise mounting the lead frame on the electrical ends protruding substantially in the axial direction from the stator. Preferably, making contact with electrical ends may comprise pressing the lead frame onto the electrical ends protruding substantially in the axial direction from the stator. In particular, making contact with electrical ends may comprise mounting and/or pressing the lead frame onto electrical connectors protruding axially from the stator, in particular their press-in sections. In configurations, the lead frame can be mounted or pressed onto the electrical ends in the axial direction.

In configurations of the method, making contact with electrical ends may comprise pressing electrical connectors connected to the wire ends of the stator windings into the contact elements of the lead frame. In particular, making contact may comprise pressing press-in sections into the contact elements or into their opening on the lower side.

In configurations of the method, the method may further comprise providing a stator housing. The stator housing defines an annular receiving area with a circumferential section and an annular end wall. Furthermore, the method may comprise inserting the stator, with which contact has been made, with the lead frame axially arranged thereon, into the receiving area of the stator housing. In addition, the method may comprise potting the stator with the lead frame in the stator housing by filling potting compound into the receiving area, whereby a potting body is formed between the stator, which is in contact with the lead frame, and the stator housing after the potting compound has hardened. The potting makes it possible for the stator, which is in contact with the lead frame, to be fixed in the potting body and thus in the stator housing after the potting compound has hardened. In configurations, the stator, with which contact has been made, can first be inserted with the lead frame in the axial direction into the stator housing, such that the lead frame is arranged adjacent to the annular end wall. In particular, the stator, with which contact has been made, can be inserted with the lead frame into the stator housing such that the upper side of the lead frame is arranged adjacent to the annular end wall. In configurations, a connection apparatus of the lead frame can be guided at least partially through a passage in the annular end wall to the outside of the stator housing during insertion. This allows an inverter to be electrically connected to the lead frame outside the stator housing via the connection apparatus.

In configurations of the method, a resin material, in particular a synthetic resin material, can be used as the potting compound. In configurations, the potting compound may be provided with fillers promoting heat conduction.

### BRIEF DESCRIPTION OF THE FIGURES

Further features are apparent from the accompanying drawings which form part of this disclosure. The drawings are intended to be used to further explain the present disclosure and to enable a person skilled in the art to put the present disclosure into practice. However, the drawings should be understood as non-limiting examples. Common reference numerals in different figures indicate the same or similar features.

FIG. 1 shows a schematic sectional illustration of the electrical machine of the third aspect with the stator arrangement comprising the lead frame;

FIG. 2a shows a plan view of the lead frame of the first aspect;

FIG. 2b shows a plan view of the lead frame of the first aspect, wherein only some of the contact elements are in the form of contact sleeves;

FIGS. 3a-3f show six different line planes of the lead frame in an exemplary configuration;

FIG. 4a shows a perspective partial detail of the lead frame in a sectional view;

FIG. 4b shows a perspective partial detail of the stator arrangement of the second aspect with a lead frame pressed onto the stator in the view according to FIG. 4a;

FIG. 5a shows a perspective view of an exemplary wound stator tooth with electrical connectors;

FIG. 5b shows a perspective view of a stator having a plurality of wound stator teeth with electrical connectors from FIG. 5a;

FIG. 6 shows a stator arrangement having the stator from FIG. 5b and the lead frame mounted thereon;

FIG. 7 shows the stator arrangement from FIG. 6 with an exemplary connection apparatus of the lead frame;

FIG. 8 shows the stator arrangement from FIG. 7 in an orientation when being inserted into a stator housing of the stator arrangement;

FIG. 9 schematically shows a flowchart of a method for producing a stator arrangement for an electrical machine according to the fourth aspect;

FIG. 10 shows a plan view of the lead frame in a variation;

FIGS. 11a-11b each show a detail of the lead frame from FIG. 10 with an exemplary connection apparatus.

### DETAILED DESCRIPTION

Configurations of the lead frame, the stator arrangement, the electrical machine and the method according to the present disclosure are explained below with reference to the drawings.

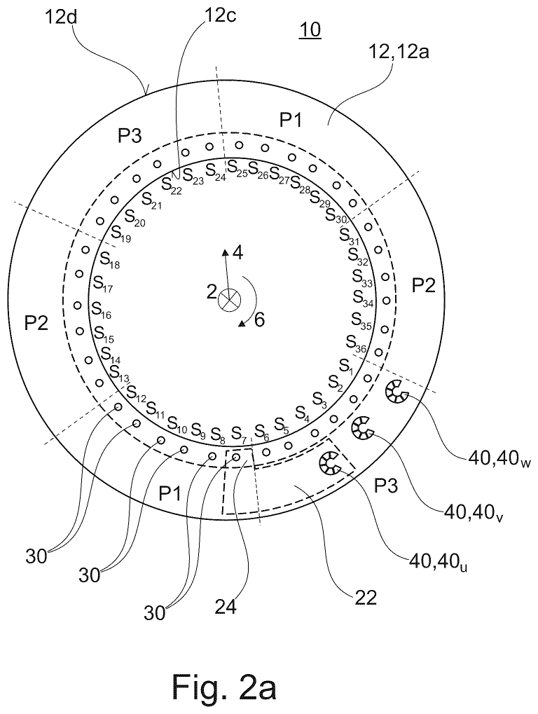

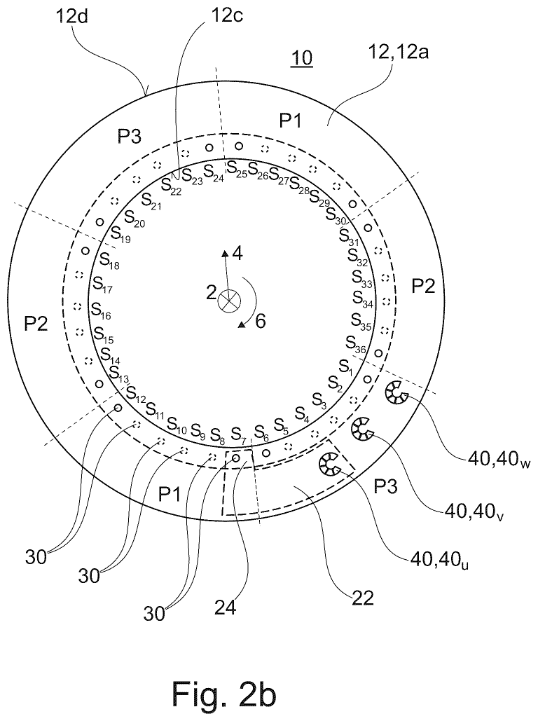

In the context of this application, the terms axially or axial direction 2 refer to a central axis of the lead frame 10 or its annular main body 12. In addition, the terms axially or axial direction 2 may refer to a rotational axis of the electrical machine 200 and to a central axis of the stator arrangement 100 or the stator 110, which are arranged concentrically to the rotational axis. Since the respective axes of the lead frame 10 of the stator 110, the stator arrangement 100 and the electrical machine 200 are substantially identical, they are shown with the same reference sign. Depending on which element or is which entity reference is made to, the (central) axis or the rotational axis may in connection with the lead frame 10, the stator 110, the stator arrangement 100, and/or the radial flux motor 200 and/or further elements or entities such as the rotor 220, the shaft 230. In the figures, the axial direction 2 is represented with the reference sign 2. The expression radially or radial direction should be understood in relation to the axis/axial direction 2 and is represented with the reference sign 4. Likewise, a circumference, circumferentially or a circumferential direction refers to the axial direction 2 and is marked with the reference sign 6. It should be understood that, although only one exemplary direction is shown in each case in the respective figures, the respective opposite direction also falls under the respective expression. For example, in FIG. 2a, the circumferential direction 6 is represented by an arrow oriented in the clockwise direction. However, an anti-clockwise direction around the axis 2 can also be referred to as the circumferential direction 6. This also similarly applies to the axial direction 2 and the radial direction(s) 4.

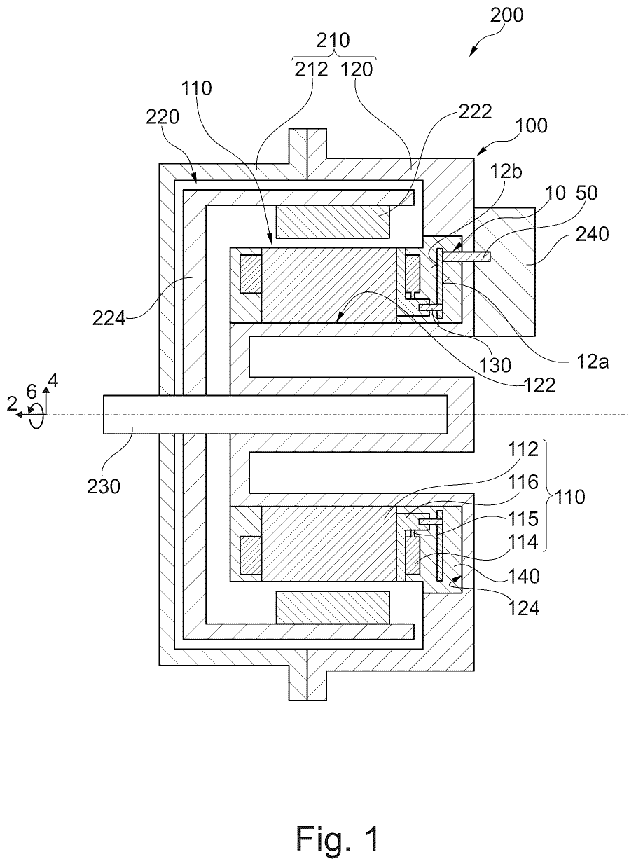

FIG. 1 shows an exemplary electrical machine 200 according to the third aspect according to the invention. FIG. 1 shows the electrical machine 200 in a schematically greatly simplified sectional illustration through a sectional plane defined by the axial direction 2 and the radial direction 4. The electrical machine 200 comprises a machine housing 210, a rotor 220, a shaft 230 and an inverter 240. In addition, the electrical machine 200 comprises a stator arrangement 100 according to the second aspect, which will be described in detail further below. The shaft 230 is mounted rotatably in the machine housing 210. For reasons of clarity, bearings of the electrical machine for rotatably mounting the shaft are not shown in the figures. The rotor 220 is arranged for conjoint rotation on the shaft 230 in the machine housing 210. Thus, the rotor 220 can rotate together with the shaft 230 about the rotor axis (dash-dotted line at reference sign 2).

The stator 110 is arranged adjacent to the rotor 220 in the machine housing 210. In the example in FIG. 1, the electrical machine 200 is in the form of a radial flux motor. The stator 110 is arranged radially adjacent to the rotor 220 in the machine housing 210. In other words, the stator 110 and the rotor 220 are spaced apart from each other by a gap in the radial direction 4. The exemplary configurations of the electrical machine 200 shown in the figures relate to a radial flux motor with an external rotor 220. The rotor 220 is arranged radially outside the stator 110 or surrounds the stator 110 (at least partially) radially on the outside. In this case, stator teeth 112 of the stator 110 project outward in the radial direction 4 to the rotor 220. As explained in detail further below, the stator 110 comprises a plurality of stator teeth 112 which are wound with winding wire in order to form a stator winding 114 on a stator tooth 112.

As shown in FIG. 1, the rotor 220 comprises a plurality of rotor poles 222 which are arranged so as to be distributed in the circumferential direction 6 on a rotor body 224 of the rotor 220. In alternative terms, the rotor 220 comprises a rotor body 224 and a plurality of rotor poles 222. The rotor poles 222 can be in the form of permanent magnets, in particular. The rotor poles 222 are arranged so as to be distributed in the circumferential direction 6 on the rotor body 224 of the rotor 220. In the exemplary illustration in FIG. 1, the rotor body 224 of the rotor 220 is pot-shaped. The rotor poles 222 can be arranged on an inner circumference of the rotor body 224. In particular, the rotor poles 222 are magnetized in the radial direction 4. Applying current to the stator 110 or its stator windings 114 makes it possible to generate a magnetic flux in the radial direction 4 during operation, which induces, in the rotor poles 222 (e.g. permanent magnets 222), a force that drives the rotor 220 (and thus the shaft 230).

In alternative configurations, however, the present disclosure also extends to radial flux machines with an internal rotor. As an alternative to a radial flux machine, the electrical machine may also be in the form of an axial flux machine, in which a disk-shaped or annular rotor is arranged so as to be spaced apart from a disk-shaped or annular stator by a gap in the axial direction 2. In an axial flux machine, the stator teeth of the stator project in the axial direction to the rotor and the rotor poles of the rotor are magnetized in the axial direction, with the result that magnetic flux can be generated in the axial direction in an axial flux machine.

Further, with reference to FIG. 1, the machine housing 210 may comprise a rotor housing 212 and a stator housing 120. The rotor housing 212 and the stator housing 120 may be connected to each other in a force-fitting manner, in particular. Respective flanges on the rotor housing 212 and the stator housing 120 can be seen in this regard in FIG. 1 and can be used to produce a force-fitting connection (e.g. via one or more screw connections not shown) between the two housings 212, 120.

The inverter 240 is designed to control the stator 110. Furthermore, the inverter 240 is electrically connected to a lead frame 10 of the stator arrangement 100, which is described in detail below. In this respect, a connection apparatus 50 of the lead frame 10 can be seen in FIG. 1 and can be used to electrically connect the inverter 240 to the lead frame 10.

The lead frame 10 for making electrical contact with stator windings 114 of a three-phase stator 110 according to the first aspect according to the invention is described below, in particular with reference to FIGS. 2a, 2b, 3a-3f, 4a, 4b, 7, 10.

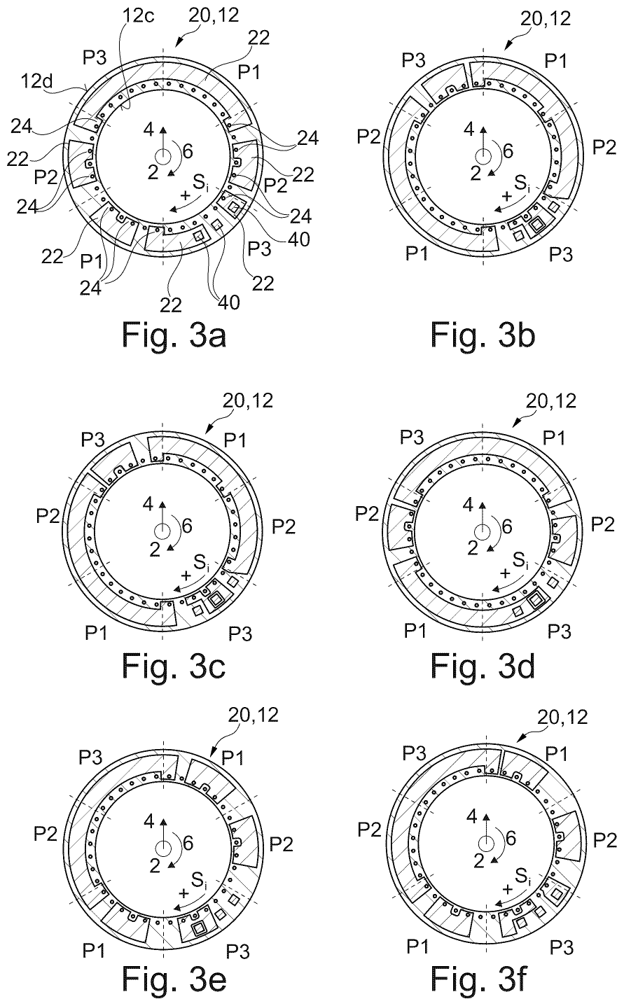

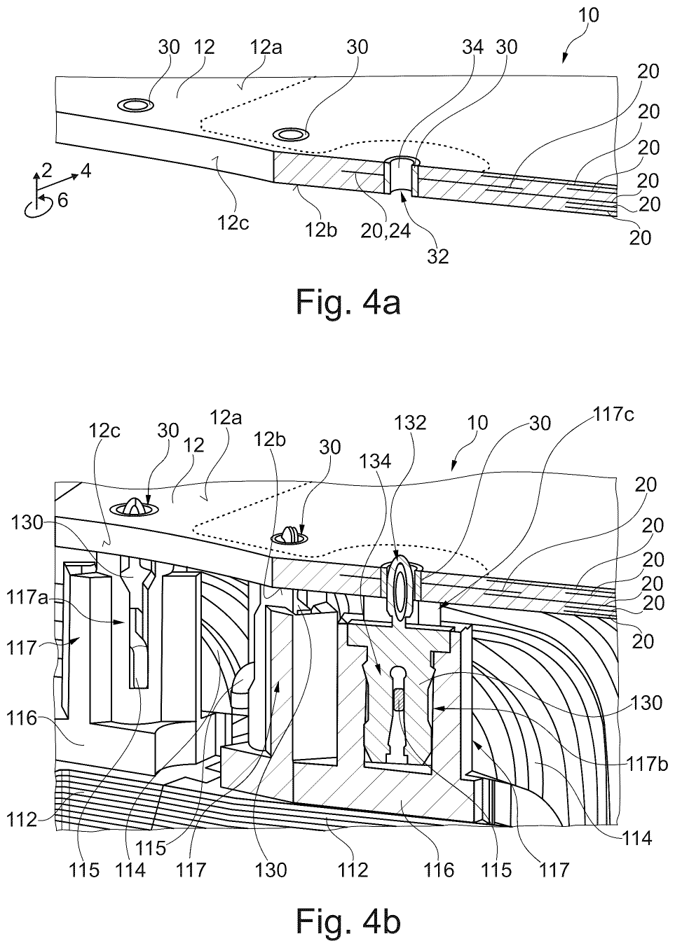

As can be seen in particular in FIGS. 2a, 2b and 3a-3f, 10, the lead frame 10 comprises an annular main body 12, three connection contacts 40 (40u, 40v, 40w), a plurality of line planes 20 and a plurality of electrically conductive contact elements 30. The annular main body 12 has an upper side 12a and a lower side 12b (see also FIG. 4a for example). It should be understood that “annular” may also include shapes that deviate from a perfect circle, such as oval or polygonal. Shapes which comprise one or more (for example radially protruding) sections that protrude from the annular main body 12 (e.g. its inner circumference 12c and/or its outer circumference 12d) may also be included. The three connection contacts 40 are designed to make electrical contact between a respective stator phase (P1, P2, P3) and an inverter 240 on the inverter side. The plurality of line planes 20 are arranged in an axially insulated manner in the annular main body 12. The line planes 20 have a plurality of line sections 22 spaced apart in the circumferential direction 6 (see FIGS. 3a-3f). The plurality of electrically conductive contact elements 30 extend axially through the annular main body 12 (see also FIG. 4a). Furthermore, contact elements 30 are arranged so as to be distributed in the circumferential direction 6. In addition, the contact elements 30 are arranged in a manner radially spaced apart from the line sections 22. The line planes 20 also have line tabs 24 which radially protrude from the line sections 22 and electrically connect the line sections 22 to the contact elements 30 (see, for example, FIGS. 3a-3f). The line tabs 24 are arranged in such a way that an electrical interconnection of the stator phases (P1, P2, P3) between the contact elements 30 and the connection contacts 40 is provided by the line planes 20 and the contact elements 30. Furthermore, at least some of the plurality of contact elements 30 are designed to make electrical contact with the stator windings 114. Line sections 22 of different line planes 20 can be electrically connected to each other by means of line tabs 24 and contact elements 30. Thus, the contact elements 30 can serve as a type of plane contact-making means or throughplating means between different line planes 20 having a line tab 24 in the region of the same contact element 30. In addition, the at least some contact elements 30, which are designed to make electrical contact with the stator windings 114, make it possible on the one hand to connect a stator winding 114 to the contact element 30 and on the other hand to use this contact element 30 to electrically connect one or more line sections 22 electrically connected thereto to the stator winding 114.

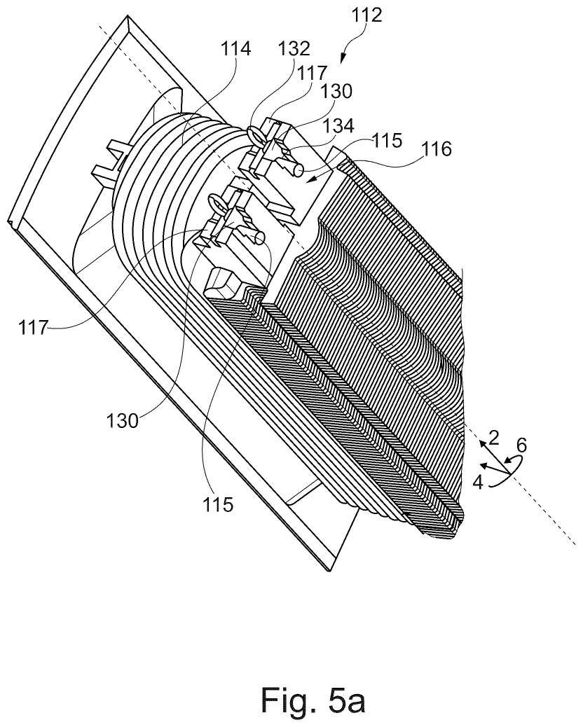

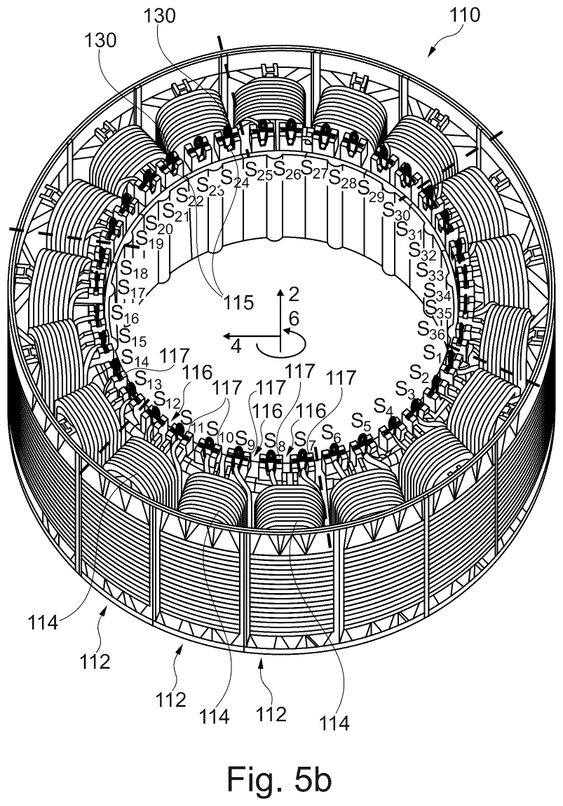

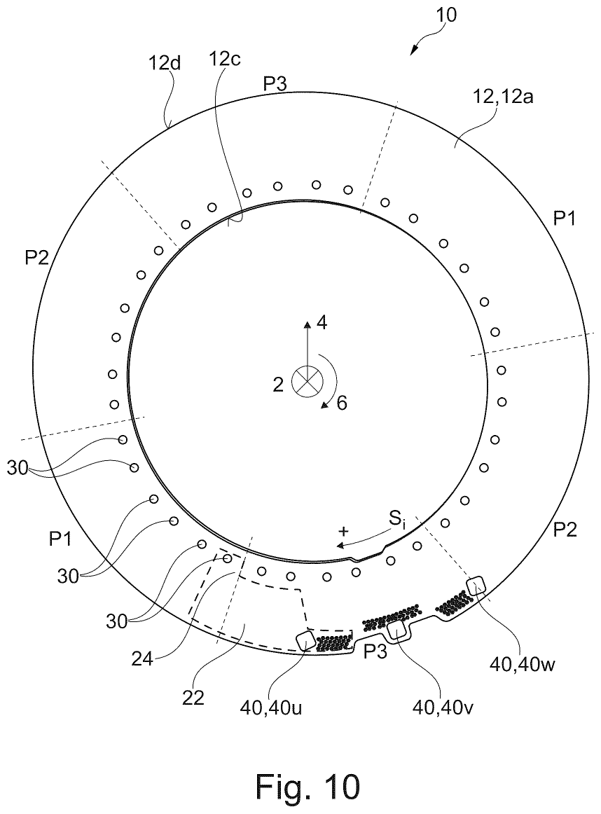

In the exemplary configuration of the lead frame 10 from FIG. 2a and FIG. 2b (also FIGS. 3a-3f and 10), the lead frame 10 has a number of 36 contact elements 30. For reasons of clarity, only 6 contact elements 30 are each provided with a reference sign in FIGS. 2a, 2b and 10. It should also be understood that the circular elements in the radially inner area of the annular main body 12 which are shown in FIGS. 3a-3f, 6 and 7 indicate contact elements 30. In alternative configurations, a lead frame 10 may also have more or less than 36 contact elements 30. For example, the lead frame 10 may comprise a number of 6 to 72 contact elements 30. In particular, the lead frame 10 may comprise a number of 12 to 36 contact elements 30. As can be gathered from FIGS. 2a, 2b and 10, the contact elements 30 are arranged at positions Sᵢ distributed in the circumferential direction 6. In this case, “i” stands for the ascending number of the position. In the present example with 36 contact elements 30, there are therefore 36 positions S₁ to S₃₆ which are numbered consecutively in the clockwise direction. The positions Sᵢ are assigned to areas of stator windings 112 of a respective stator phase (P1, P2, P3) (see also FIG. 5b). In the example in FIGS. 2a, 2b, 3a-3f, 5b and 10, two positions Sᵢ are assigned to each stator winding 114. The “positions Sᵢ distributed in the circumferential direction 6” can also be referred to as circumferential positions. A circumferential position may include any position arranged on a radial vector passing through the circumferential position. “Areas of stator windings 114” can be understood as meaning, in particular, circumferential areas or circumferential sectors in which the stator winding 114 or the stator tooth 112, in particular wire ends 115 of the stator windings 114, is/are arranged.

In the illustrated configuration examples, the contact elements 30 are arranged radially within the line sections 22. In other words, the contact elements 30 are arranged in a radially inner area of the annular main body 12. This area is indicated, by way of example, in FIGS. 2a and 2b by the dashed circle around the axial direction 2. In alternative configurations, the contact elements 30 can also be arranged radially outside the line sections 22 or in a radially outer area of the annular main body 12. It would also be conceivable for some contact elements 30 to be arranged radially inside and for some contact elements 30 to be arranged radially outside the line sections 22. In addition, the contact elements are arranged so as to be spaced apart from an inner circumference 12c of the annular main body 12 and/or from an outer circumference 12d of the annular main body 12. Although a greater holding force of the contact elements 30 in the annular main body 12 can be achieved thereby, some contact elements 30 can also be arranged on the inner circumference 12c and some contact elements 30 can be arranged on the outer circumference 12d. All contact elements 30 could also be arranged on the inner circumference 12c or on the outer circumference 12d.

A line plane 20 can be understood as meaning an electrically conductive area having line sections 22 and line tabs 24 within an axial plane or a position in the axial direction 2. In this respect, FIGS. 3a-3f show six line planes 20 of an exemplary configuration of the lead frame 10 in an axial direction 2 from the upper side 12a in the direction of the lower side 12b. FIGS. 3a-3f thus show exemplary sections through the lead frame 10 in different axial planes in which the line planes 20 are arranged. FIG. 3a shows a first line plane 20. FIG. 3b shows a second line plane 20. FIG. 3c shows a third line plane 20. FIG. 3d shows a fourth line plane 20. FIG. 3e shows a fifth line plane 20. FIG. 3f shows a sixth line plane 20. The first line plane 20 is arranged closest to the upper side 12a. The sixth line plane 20 is arranged closest to the lower side 12b. The remaining four line planes 20 are located in between according to their numbering.

In configurations, the lead frame 10 or its annular main body 12 may have a multi-layer printed circuit board structure. The line planes 20 are located in a respective layer or plane of the multi-layer printed circuit board structure. The printed circuit board structure can also be referred to as a “circuit board structure”. In such configurations, the lead frame 10 can also be referred to as a printed circuit board lead frame. For example, the line planes 20 (i.e. the electrically conductive areas) can be produced by means of known printing techniques. In particular, in such cases, it is also possible to refer to a printed circuit board structure. The term “PCB structure” (printed circuit board) can be used for this. If the lead frame 10 has a PCB structure, the lead frame 10 can also be referred to as a PCB lead frame 10. As an alternative to printing the line planes 20, other methods for producing the line planes 20 and the lead frame 10 are also conceivable.

In particular, the line planes 20 are embedded in a substrate. The substrate may be produced, for example, from conventional printed circuit board substrate material, such as glass fiber, Teflon®, ceramic, polymers or glass fiber epoxy laminate. The line planes 20 can be electrically isolated from each other by embedding them in the substrate. This is clear, for example, in FIG. 4a, wherein the line planes 20 are axially insulated from each other by the substrate. As becomes clear in particular from FIGS. 3a-3f, the line sections 22 extend in a band-like manner in the circumferential direction 6. The line sections 22 of a line plane 20 are electrically insulated from each other in the circumferential direction 6 by the substrate.

The line tabs 24 are connected to the line sections 22 in an electrically conductive manner in order to produce an electrical connection between a line section 22 and a contact element 30. A line tab 24 is in particular assigned to only a single line section 22 or is electrically connected to this. In particular, each line section 22 is connected to at least one line tab 24. Line sections which are not connected directly to a connection contact 40 or are connected via a conductor pin arrangement comprise, in particular, at least two line tabs 24. As becomes clear from FIGS. 3a-3f, the line tabs 24 are directly physically connected to the line sections 22.

In particular, the line tabs 24 are arranged only at those positions Sᵢ in a respective line plane 20 which are required for the electrical interconnection of the stator phases P1, P2, P3 of the line section 22 connected to the line tab 24. In general, the three stator phases P1, P2, P3 can be referred to as phases U, V, W, where, for example, P1=U, P2=V and P3=W. However, the stator phases P1, P2, P3 could also be arranged in a different interconnection. In the configurations described in detail here, the stator phases P1, P2, P3 are arranged in two phase groups of six contact elements 30 and three stator teeth 112 each (see also FIG. 5b). The phase groups are shown in the figures in a manner separated from each other by dashed lines in the radial direction 4 and are marked with the respective stator phase P1, P2, P3 (see e.g. FIGS. 2a, 2b, 3a-3f, 5, 6, 7, 10).

An exemplary line section 22 with a line tab 24 in the first line plane 20 is indicated by the dashed border in FIGS. 2a, 2b and 10. The exemplary line section 22 extends, as can be seen in the figures, approximately from the circumferential position at S₄ to the circumferential position S₇. The line section 22 is electrically connected to the connection contact 40, 40u and is radially spaced apart from the contact elements 30 at the positions S₄, S₅, S₆ and S₇. The line section 22 is electrically connected to the contact element 30 at the position S₇ via the line tab 24 protruding radially inward from the line section 22. It is therefore possible to produce, by way of example, an electrically conductive connection from a connection contact 40 to a contact element 30 via a line section 22 and a line tab 24. Since the line planes 20 in FIGS. 3a-3f are arranged in the same rotational position, the further electrical flux (during operation) or the electrically conductive connection can thus be traced. In this respect, the position at the reference sign Sᵢ represents the first position Sᵢ. The same applies to the lead frame 10 in FIG. 10, in which the reference sign Sᵢ represents the first position Sᵢ. Following in the clockwise direction, the contact elements 30 are shown in ascending order at the further positions Sᵢ. The exemplary line section 22 with the line tab 24 can also be seen (in the lower area at about six o'clock) in FIG. 3a in the circumferential area corresponding to the exemplary line section 22 in FIGS. 2a and 2b. The electrical flux can now be conducted, for example, from the contact element 30 at the position S7 into a wire end 115 at the position S7 and through a stator winding 114. At the other wire end 115 of this stator winding 114 at the position S₈, the electrical flux can be conducted, via the contact element 30, into the line tabs 24 of the fifth line plane 20 (see FIG. 3e) and of the sixth line plane 20 (see FIG. 3f) that are arranged at the position S₈ and into the line sections 22 connected thereto. The configurations described here and illustrated in the figures should only be understood as exemplary configurations of the lead frame 10, in particular its line planes 20, for the purpose of explaining the basic principle. A wide variety of configurations of the line planes 20, line sections 22 and line tabs 24 are included in the scope of the present disclosure.

In particular, the configuration of the line planes 20 can be adapted to a configuration of the stator 110 used with the lead frame 10. In configurations, a configuration of the line planes 20 can be adapted to a desired interconnection, for example to a star circuit or a delta circuit, of the stator phases P1, P2, P3. For example, a different number of line planes 20 can be used or arranged in the annular main body 12. In configurations, the line planes 20 may also have different numbers of line sections 22, for example at least two, preferably at least three, and particularly preferably at least four, line sections 22 spaced apart from each other, in particular spaced apart from each other in the circumferential direction 6.

Further, in relation to FIGS. 3a-3f, the line tabs 24 can completely surround the contact elements 30 in the radial direction 2 and in the circumferential direction 6. This makes it possible to achieve reliable electrical contact between the line tabs 24 and the contact elements 30. In configurations, however, the line tabs 24 may also surround the contact elements 30 only at least partially in the radial direction 4 and/or at least partially in the circumferential direction 6.

In configurations of the lead frame 10, a radial width of the annular main body 12 between an inner diameter of the annular main body 12 and an outer diameter of the annular main body 12 can be 40 mm, in particular. It goes without saying that the inner diameter is in contact with the inner circumference 12c of the annular main body 12. In addition, the outer diameter is in contact with the outer circumference 12d of the annular main body 12. In alternative configurations, the radial width of the annular main body 12 can be 20 mm or more. Preferably, the radial width of the annular main body 12 can be 30 mm or more. Particularly preferably, the radial width of the annular main body 12 can be 40 mm or more. In configurations, the radial width of the annular main body 12 can be between 20 mm and 80 mm, preferably between 30 mm and 60 mm, and particularly preferably between 25 mm and 45 mm. In configurations, the radial width of the annular main body may correspond substantially to a radial width of the stator 110 between its inner circumference and outer circumference. For example, this may include radial widths of 75% to 125% of the radial width of the stator 110. In some configurations, the inner diameter of the annular main body 12 may be, for example, 160 mm. In alternative configurations, the inner diameter of the annular main body 12 may also be smaller or larger. For example, the inner diameter on the inner circumference 12c of the annular main body 12 may be, for example, 50 mm to 500 mm, preferably 100 mm to 250 mm, and particularly preferably 125 mm to 200 mm.

An axial thickness of the annular main body 12 between the upper side 12a and the lower side 12b can be 1 mm to 5 mm, preferably 1.2 mm to 2 mm, and particularly preferably 1.4 mm to 1.8 mm. Such an axial thickness of the annular main body 12 makes it possible to reduce installation space required in the axial direction 2, for example in comparison with a conventional lead frame.

The line sections 22 extend at least in sections in the radial direction 4 at least over 40% of the radial width of the annular main body 12. Preferably, the line sections 22 can extend at least over 50% of a radial width of the annular main body 12. Particularly preferably, the line sections 22 can extend at least over 60% of a radial width of the annular main body 12. Such a designed radial width of a line section 22 makes it possible to use an available total width (i.e. the radial width of the annular main body 12) to a greater extent compared to, for example, conventionally used copper strips. In other words, in order to achieve a sufficient line cross section, which is necessary for the current flow, an axial thickness of the line sections 22 can be significantly reduced by this flat design of the line sections 22 in comparison with a conventional lead frame. The radial width of a line section 22 can be understood as meaning, in particular, a maximum radial width of the line section 22. In other words, separated line sections 22, in particular separated line sections 22 in circumferential areas of the connection contacts 40, can have smaller radial widths at least in sections (see, for example, the line section 22 at the connection contacts 40 in FIG. 3b).

The schematic representation in FIG. 4a shows a sectional view through the lead frame 10, with the result that the line planes 20 axially spaced apart and a cut-away contact element 30 can be seen. In order to better indicate the line planes 20, they are not shown to scale at least in the axial direction 2, but are shown thicker. In configurations of the lead frame 10, an axial thickness of a line plane 20 may be 200 μm or less, preferably 150 μm or less, and particularly preferably 125 μm or less. For example, the axial thickness of a line plane 20 may be 50 μm to 150 μm, preferably 70 μm to 130 μm, and particularly preferably 80 μm to 120 μm. In configurations, the axial thickness of a line plane 20 may be at least 50 μm or at least 75 μm. Such a designed axial thickness of a line plane 20 (and thus also such a designed axial thickness of the line sections 22 and the line tabs 24) makes it possible to greatly reduce axial installation space compared to copper strips conventionally used in lead frames.

In configurations, the axial thickness of a line plane 20 can be smaller than a radial width of the line plane 20 at least by a factor of 20. In particular, the axial thickness of a line plane 20 can be smaller than a radial width of the line plane 20 at least by a factor of 50. Preferably, the axial thickness of a line plane 20 can be smaller than the radial width of the line plane 20 at least by a factor of 100. Particularly preferably, the axial thickness of a line plane 20 can be smaller than the radial width of the line plane 20 at least by a factor of 200. In particular, an axial thickness of a line section 22 may be smaller than a radial width of the line section 22 at least by a factor of 20, preferably at least by a factor of 50, and particularly preferably at least by a factor of 100 or a factor of 200. Such a designed axial thickness of a line plane 20 (or of the line sections 22 and the line tabs 24) makes it possible to reduce an axial total thickness of the annular main body 12 between the upper side 12a and the lower side 12b. Overall, it is thus possible to reduce the required installation space in the axial direction 2.

As can be seen in particular in FIG. 4a, the contact elements 30 comprise an opening 32 on the lower side 12b for making electrical contact with the stator windings 114. In addition, the contact elements 30 have a passage 34 which extends from the opening 32 to the upper side 12b. In this case, the passage has the opening 32 on the lower side 12b and an opening on the upper side 12a. That is to say, the contact elements can be of sleeve-like design. Contact elements 30 with a passage 34 can also be referred to as contact sleeves. The passage 34 can extend (as shown in FIG. 4b) substantially in the axial direction 2. In some configurations, the contact elements can be in the form of VIA sleeves (VIA; vertical interconnect access).

In alternative configurations of the lead frame 10, only the at least some of the plurality of contact elements 30 may have an opening 32 on the lower side 12b and/or a passage 34 for making electrical contact with the stator windings 114. Whereas FIG. 2a shows a lead frame 10 in which all contact elements 10 are in the form of contact sleeves, FIG. 2b shows an exemplary variation in which only some of the plurality of contact elements 30 have an opening 32 and a passage 34. In the exemplary embodiment illustrated, these are the twelve contact elements 30 at the positions S₁, S₆, S₇, S₁₂, S₁₃, S₁₈, S₁₉, S₂₄, S₂₅, S₃₀, S₃₁ and S₃₆. Such a configuration may be advantageous in particular when the lead frame 10 is used with those configurations of stators 110 in which a plurality of stator teeth 112 are wound by a single winding wire 114, that is to say in winding groups. For example, adjacent stator teeth 112 in the circumferential area of the positions S₁ to S₆, S₇ to S₁₂, S₁₃ to S₁₈, S₁₉ to S₂₄, S₂₅ to S₃₀ and S₃₁ to S₃₆ may each be wound in a winding group. In this case, for example, contact would need to be made between the winding group with three wound stator teeth 112 of the positions S₁ to S₆ and the lead frame 10 only via two wire ends 115, for example a wire end 115 at the position S₁ and a wire end at the position S₆. In more general terms, only two contact elements 30 with an opening 32 on the lower side 12b and/or a passage 34 may be formed within a circumferential area of a phase group which is wound as a winding group. In alternative configurations in which phase groups and/or winding groups are used, in particular all contact elements 30 can also be of the same design, in particular with an opening 32 on the lower side 12b and/or a passage 34.

In particular, the contact elements 30 for making contact with the stator windings 114 can be provided in a number of wire ends 115 which are present in the stator 110 with which contact is to be made. In some configurations, the number of contact elements can correspond to the number of wire ends 115 which are present in the stator with which contact is to be made.

In a few alternative configurations, the number of the at least some of the plurality of contact elements 30 may correspond to n times the number of wire ends 115, where n corresponds to a fraction of less than 1 and greater than 0 or a positive natural number. In other words, more contact elements 30 than required can also be designed to make contact. Conversely, it is also possible to make contact with a plurality of wire ends 115, for example two, three or more, via a (single) contact element 30.

In particular, the openings 32 may be configured such that the lead frame 10 can be mounted on electrical ends of the stator 110. In other words, at least one recess in the contact element 30 is formed by the opening 32, into which electrical ends of the stator 110 (for example wire ends or electrical connectors connected thereto) can be inserted when assembling the lead frame 10 with the stator 110. For example, the lead frame 10 can be mounted or plugged onto the electrical ends. As a result of the fact that the contact element 30 is made of an electrically conductive material, the lead frame 10 can therefore be mounted on the stator 110 and electrical contact can be made with the stator 110 in a simple manner.

The electrical ends of the stator 110 can be understood as meaning those line ends that are in electrical contact with the lead frame 10. For example, these can be wire ends 115 of the winding wire 114 or electrical connectors 130. The electrical connectors 130 can be electrically connected to the wire ends 115. When mounted, the electrical connectors 130 may be arranged between the wire ends 115 and the lead frame 10. Especially in the case of electrical connectors 130, the lead frame 10 can be pressed onto the electrical ends.

The passage 34 can provide space for the electrical ends, in particular for electrical connectors 130, which can be inserted, in particular can be pressed, into the contact elements 30 or their passages 34. Providing a press-in option for the electrical ends makes it possible to make contact with and assemble the line arrangement 10 and the stator 110 in a considerably simpler manner, for example, compared to making contact by welding. In the exemplary embodiment shown in FIG. 4a, the passage 34 is cylindrical. In alternative configurations, the passage 34 can be designed to taper toward the upper side 12. In configurations, the taper may be conical or bent, for example. The taper can improve holding of the electrical ends and/or a fit of the lead frame 10 on the electrical ends. In addition, the taper can improve positioning of the lead frame 10 on the stator 110 during the mounting process.

In advantageous configurations of the lead frame 10, the contact elements 30 may be designed to press in electrical connectors 130 of the stator windings 114 of the stator 110. In particular, the at least some of the plurality of contact elements 30 may be designed such that the lead frame 10 can be pressed onto the electrical connectors 130. This can be achieved, for example, by a tapering configuration of the passages 34 and/or by a dimensional and/or geometric adjustment of the contact elements 30 (in particular their openings 32 and/or their passages 34).

In configurations of the lead frame 10, the connection contacts 40 can be electrically connected directly to at least one line plane 20. In particular, the connection contacts 40 may be electrically connected to a line section 22 and/or a line tab 24 in at least one line plane 20. This has already been explained further above in relation to the exemplary line section 22 from FIGS. 2a, 2b and 10. For this purpose, the connection contacts 40 can extend, for example, at least partially in the axial direction 2 into the annular main body 12. See also in this respect, for example, the line sections 22 in the first line plane 20 in FIG. 3a and the sixth line plane 20 in FIG. 3f, which are electrically connected to the connection contact 40 in the circumferential area of the position S₁ (similarly see also the connection contact 40 in the circumferential area between the positions S₂ and S₃ and the corresponding line section in the fourth line plane 20 in FIG. 3d). Alternatively or additionally, a connection contact 40 can also be electrically connected to at least one line plane 20 via a conductor pin arrangement (see, for example, lead frame 10 from FIG. 10). The conductor pin arrangement may be electrically conductive. The conductor pin arrangement may extend in the axial direction 2. In configurations, the conductor pin arrangement may comprise at least one or more conductor pins. The conductor pin arrangement can be arranged in a manner radially and/or circumferentially spaced apart from the line sections and can be connected to the line sections via connection tabs.

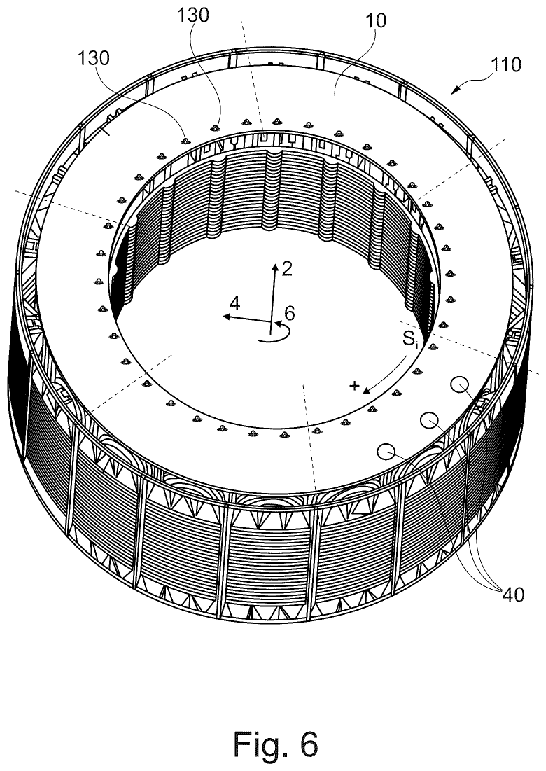

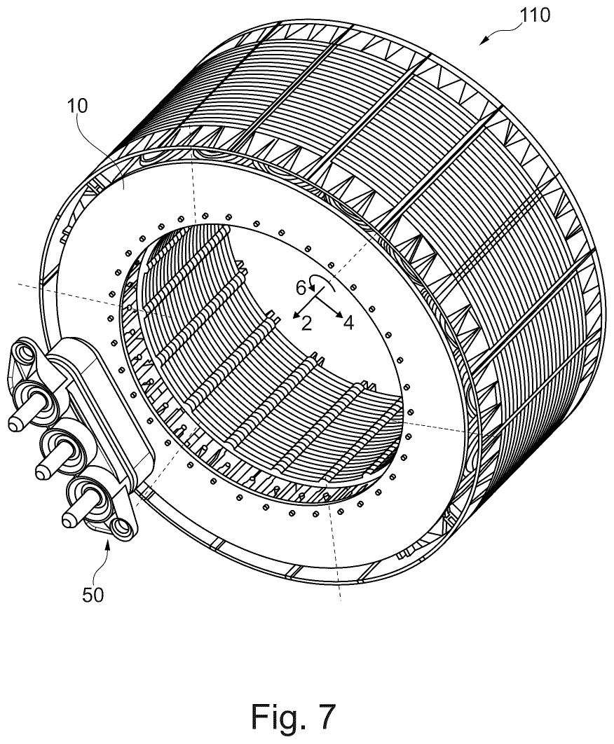

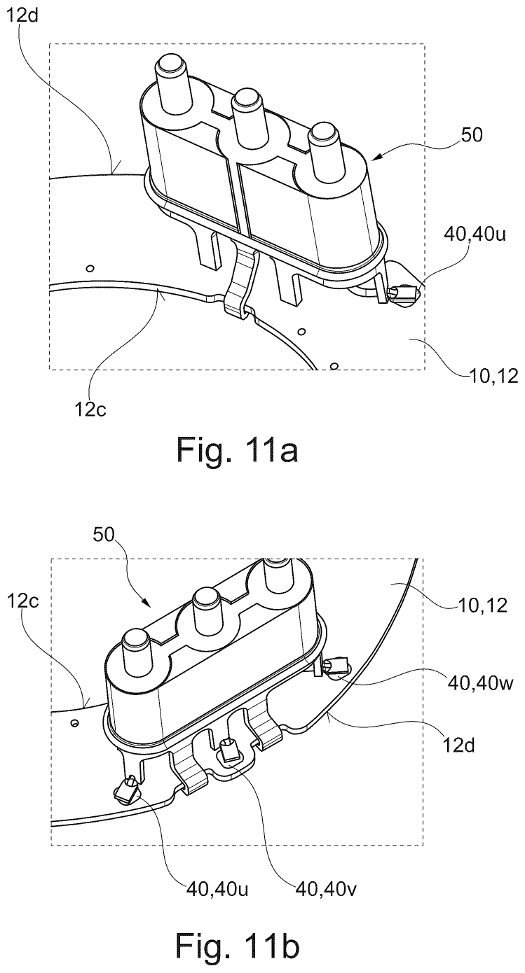

As already mentioned in relation to FIG. 1, the lead frame 10 may further comprise a connection apparatus 50. The connection apparatus 50 is electrically connected to the connection contacts 40 for making electrical contact between a respective stator phase P1, P2, P3 and the inverter 240. As can be seen in particular in FIGS. 2a, 2b and 10 as well as FIG. 6, which show the lead frame 10 without the connection apparatus 50, the connection contacts 40 are arranged on the upper side 12a of the annular main body 12 (alternatively, the connection contacts 40 may be arranged, for example, on another outer surface of the annular main body 12). Accordingly, as shown in FIGS. 7, 11a and 11b, the connection apparatus 50 can be arranged on the upper side 12a of the annular main body 12. In configurations, the connection apparatus 50 can be arranged axially above the connection contacts 40. For this purpose, the connection apparatus 50 may comprise spacers, for example. In configurations of the lead frame, the connection apparatus 50 can be fastened to the annular main body 12 in a floating manner. This makes it possible to compensate for tolerances when mounting the lead frame 10 in a stator housing 120. “Floating” can be understood as meaning relatively movable (in particular radially and/or circumferentially and/or axially movable) within certain limits in such a way that manufacturing and/or mounting tolerances can be compensated for. This can be achieved, for example, by means of an elastic connecting element (for example a spring element or a rubber-like material) between the connection apparatus 50 and the annular main body 12.

In configurations, as can be seen in FIGS. 11a and 11b, the connection apparatus 50 can be fastened to the annular main body 12 via a clip connection. For example, one or more clip arms can grip the lower side 12b of the annular main body 12. The clip connection or its clip arm(s) may be elastically and/or circumferentially movable in order to provide floating fastening. For example, a cutout may be formed in the annular main body 12 in the area of a clip arm, which cutout has a larger width in the circumferential direction 6 than the clip arm, with the result that the clip arm can move within the cutout in the circumferential direction. In this respect, the lead frame 10 in FIG. 10 has corresponding cutouts. In the exemplary embodiment illustrated, a cutout is arranged on the inner circumference 12c and two cutouts are arranged on the outer circumference 12d. This makes it possible to provide an increased holding force. In other configurations, however, more or fewer than three cutouts may also be provided in the lead frame 10. For example, at least one cutout may be arranged on the inner circumference 12c and at least one cutout may be arranged on the outer circumference 12d. The number of clip arms on the connection apparatus can correspond in particular to the number of cutouts in the annular main body 12.

The connection apparatus 50 can comprise a housing, three main line pins and three cables for the electrical connection between the main line pins and the connection contacts 40 (see FIG. 7; due to the mounted view, cables can be only partially seen in FIGS. 11a and 11b). The main line pins can be fastened in the housing. In configurations, the main line pins may be surrounded at least partially by a two-component encapsulation. The two-component encapsulation can form a section of the housing or the entire housing of the connection apparatus 50. The two-component encapsulation makes it possible to save sealing elements that are otherwise additionally required. In particular, the main line pins can protrude in the axial direction 2 from the housing (preferably in the direction away from the annular main body 12, as shown in FIGS. 7, 11a and 11b). In some configurations, the cables can be ultrasonically welded to the connection contacts 40.

In configurations of the lead frame 10, the annular main body 12 may comprise a radial bulge on which the connection contacts 40 are arranged (not shown in the figures). In particular, the bulge can protrude radially outward over the outer circumference 12d.

The stator arrangement 100 for the electrical machine 200 according to the second aspect according to the invention is described in particular in relation to FIGS. 1, 4b, 5a, 5b, 6, 7 and 8. The stator arrangement 100 comprises a stator 110 and a lead frame 10 according to the first aspect. The stator 110 comprises a plurality of stator teeth 112 wound with winding wire in order to form a stator winding 114 on a stator tooth 112. The lead frame 10 is arranged at an axial end of the stator 110 and is electrically connected to electrical ends of the stator 110 for interconnecting the stator phases P1, P2, P3. In particular, the lead frame 10 can be electrically connected to wire ends 115 of the winding wire for interconnecting the stator phases P1, P2, P3. In configurations, the lead frame can be electrically connected to the wire ends 115 directly or can be electrically connected to the wire ends 115 via electrical connectors 130. In other words, the expression “electrically connected” to wire ends may include both a direct contact connection and an electrical connection implemented via an electrical connector 130. The stator arrangement 100 with the lead frame 10 can simplify mounting and/or production. In addition, especially when using a plug connection, the risk of contamination during production, such as in the case of alternative welding methods, can be eliminated or at least reduced. Furthermore, an axial (relative to an axis of the stator 110) thickness of the stator arrangement 100 can be reduced by the line-plane structure of the lead frame 10.

FIG. 5a shows an exemplary stator tooth 112 of the stator 110. As already mentioned, the stator tooth 112 is wound with a winding wire in order to thus form a stator winding 114. FIG. 5b shows the stator 110 comprising a plurality of stator teeth 112, wherein the stator teeth 112 are arranged so as to be distributed in the circumferential direction 6. In the example shown, the stator 110 is modular with individual (separate) stator teeth 112 which are mounted together. Alternatively, the stator 110 can also be constructed in one piece with a plurality of stator teeth 112. For example, an annular stator yoke with stator teeth radially protruding therefrom may be provided for this purpose. The modular stator teeth 112 or the one-piece stator 110 can be produced from conventional laminated cores.

As is clear from FIGS. 5a and 5b, the stator teeth 112 are individually wound with a winding wire. Thus, each stator tooth 112 or each stator winding 114 has two wire ends 115 each. As already explained further above, the stator phases P1, P2, P3 are arranged in two phase groups of six contact elements 30 and three stator teeth 112 each (see FIG. 5b). The stator teeth 112 or the stator windings 114 and their wire ends 115 at the positions S₇, S₈, S₉, S₁₀, S₁₁, S₁₂ form, for example, a phase group of the stator phase P2 (or V). As also already mentioned further above, in alternative configurations, the stator teeth 112 of a phase group can also be wound in winding groups with a common winding wire. In such an example, it would be necessary to make contact between the winding group with the three wound stator teeth 112 and the lead frame 10 only via two wire ends 115. The phase groups and/or winding groups may also comprise a different number of adjacent stator teeth 112, for example two or four (or more) stator teeth 112. In further alternative configurations, the stator teeth may also not be arranged in phase groups, but rather one stator tooth 112 or stator winding 114 of the first stator phase P1, of the second stator phase P2 and then of the third stator phase P3 could follow one another in the circumferential direction 6 (not shown in the figures).

In particularly advantageous configurations, the stator arrangement 100 further comprises a plurality of electrical connectors 130 (see FIGS. 4b, 5a, 5b and 6). A respective wire end 115 of the winding wire can be electrically connected to the lead frame 10 via one of the plurality of electrical connectors 130.

The stator 110 further comprises a plurality of receiving sections 117 (see FIGS. 4b, 5a and 5b). The receiving sections 117 are configured to receive the wire ends 115 and to receive electrical connectors 130. In particular, the receiving sections 117 may be configured such that, by receiving the electrical connectors 130, the wire ends 115 received in the receiving section 117 are electrically connected to the electrical connector 130. The stator phases P1, P2, P3 can then be electrically interconnected by simply making contact between the electrical connectors 130 and the lead frame 10.

A respective receiving section 117 may comprise a wire end receiving area 117a, a connector receiving area 117b and a lead frame receiving area 117c (see FIG. 4b). The wire end receiving area 117a is configured to receive a wire end 115. In particular, a respective wire end 115 can be arranged at least partially in a respective wire end receiving area 117a. The connector receiving area 117b is configured to receive an electrical connector 130. In particular, the electrical connectors 130 can be arranged at least partially in a respective connector receiving area. In particular, the wire end receiving area 117a and the connector receiving area 117b can be arranged so as to intersect each other, so that, when an electrical connector 130 is inserted into a connector receiving area 117b, a wire end arranged in the wire end receiving area 117a is cut by the electrical connector 130 with electrical contact (see FIGS. 4b, 5a and 5b).

In some configurations, a respective receiving section 117 may comprise a lead frame receiving area 117c which is configured to support the lead frame 10 (see FIG. 4b).

In some configurations, the stator may comprise a stator end cap 116. The receiving sections 117 may be integrated in the stator end cap 116 of the stator 110. For example, the stator may be encapsulated with the stator end cap 116. The stator end cap 116 may be produced, for example, from a plastic material. In configurations, the stator end cap 116 may be in one piece or, as can be seen in FIG. 5a, may be of multi-piece design with a plurality of stator end cap sections 116, each on a stator tooth 112. The stator end cap 116 is arranged at least at the axial end of a stator tooth 112 or the stator teeth 112. The winding wire may be at least partially wound around the stator end cap 116 (see FIG. 5a).

A respective electrical connector 130 may comprise in particular a press-in section 132 and an insulation displacement section 134. The press-in section 132 is configured to make electrical contact with the lead frame 10. The insulation displacement section 134 is configured to make electrical contact with a wire end 115. The press-in section 132 and the insulation displacement section 134 may be formed in particular in axially opposite end areas of the electrical connector 130. The electrical connectors 130 may each be arranged in the receiving section 117 such that a press-in section 132 of an electrical connector 130 protrudes from the receiving section 117 (see FIG. 5b). The press-in sections 132 are connected, in particular electrically connected, to the line arrangement 10 and its contact elements 30. In particular, the press-in sections 132 are pressed through the openings 32 in the passages 34 of the contact elements 30. As shown in FIGS. 4b and 6, the lead frame 10 can be mounted or pressed onto the press-in sections 132. In more general terms, the press-in section 132 of an electrical connector 130 may be connected to a contact element 30 of the lead frame 10, in particular may be pressed into a respective contact element 30. A respective insulation displacement section 134 is plugged onto a respective wire end 115. Plugging the insulation displacement section 134 onto the winding wire or its wire ends 115 makes it possible to achieve contact or electrical connection between the electrical connector 130 and the respective wire end 115 by means of a cold welding process. This in turn makes it possible to achieve electrical contact or interconnection of the stator windings 114 or stator phases P1, P2, P3 by simply connecting (in particular plugging on) the lead frame to the electrical connectors 130. In alternative terms, the lead frame 10 can be plugged, in particular pressed, onto the electrical connectors 130 for making electrical contact with the stator windings 114. In particular, the lead frame 10 can be plugged, in particular pressed, onto the electrical connectors 130 via the contact elements 30.

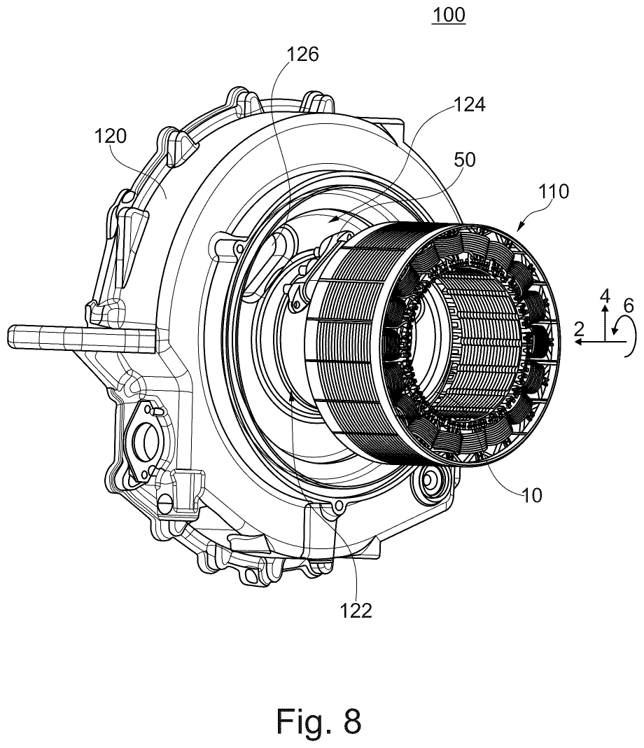

As shown in FIG. 1, the stator arrangement 100 may further comprise a potting body 140 and a stator housing 120. The stator housing 120 can define an annular receiving area with a circumferential section 122 and an annular end wall 124 (see also FIG. 8). The stator 110 may be arranged with the lead frame 10 in the receiving area such that the lead frame 10 is arranged adjacent to the annular end wall 124. In particular, the stator 110 may be arranged on the circumferential section 122. In configurations, the stator 110 may be potted with the lead frame 10 in the receiving area. The potting body 140 arranged between the stator housing 120 and the stator 110 with the lead frame 10 makes it possible to at least partially embed the stator 110 with the lead frame 10 in the potting body 140 (see FIG. 1). In configurations, the stator housing 120 may further comprise a passage 126 in the annular end wall 124 (see FIG. 8). The connection apparatus 50 of the lead frame 10 can at least partially project through the passage 126 to the outside of the stator housing 110 or its axial end wall 124 (see FIG. 1).

In configurations, the potting body 140 may comprise a resin material. In particular, the potting body 140 may comprise a synthetic resin material. In configurations, the potting body 140 may comprise particles promoting heat conduction. In particular, the particles promoting heat conduction can be produced from a non-metallic material. Thus, an impairment of the electrical and/or magnetic insulation effect of the potting body 140 can be prevented or at least reduced. For example, the potting body 140 may comprise glass fibers.

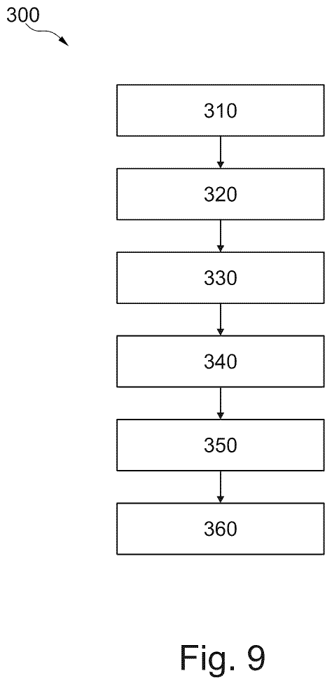

FIG. 9 shows a schematic flowchart of a method 300 for producing a stator arrangement 100 for an electrical machine 200 according to the fourth aspect. The method 300 comprises providing 310 a stator 110 having a plurality of stator teeth 212. The stator teeth 112 are wound with stator windings 114 having electrical ends. The method 300 also comprises providing 320 a lead frame 10 according to the first aspect. In addition, the method 300 comprises making contact 330 with the stator windings 114 by making contact between electrical ends of the stator windings 114 and the contact elements 30 of the lead frame 10.

In configurations of the method 300, an electrical connector 130 can be clamped onto a respective wire end 115 of the stator windings 114 in order to form electrical ends of the stator 110. The wire ends 115 of the stator windings 114 can be pressed into an insulation displacement section 134 of a respective electrical connector 130.

In configurations of the method 300, the electrical ends can be provided by inserting wire ends 115 into a wire end receiving area 117a of the stator 110 and inserting an electrical connector 130 into a connector receiving area 117b of the stator 110. In this case, an insulation displacement section 134 of the electrical connector 130 can make electrical contact with the respective wire end 115.

In configurations of the method 300, making contact 330 with electrical ends may comprise mounting the lead frame 10 on the stator 110. In particular, making contact 330 with electrical ends may comprise mounting the lead frame 10 on the electrical ends protruding substantially in the axial direction from the stator 110. Preferably, making contact 330 with electrical ends may comprise pressing the lead frame 10 onto the electrical ends protruding substantially in the axial direction from the stator 110. In particular, making contact 330 with electrical ends may comprise mounting and/or pressing the lead frame 10 onto electrical connectors 130 protruding axially from the stator, in particular their press-in sections 132. In configurations, the lead frame 10 can be mounted or pressed onto the electrical ends in the axial direction 2.

In configurations of the method 300, making contact 330 with electrical ends may comprise pressing electrical connectors 130 connected to the wire ends 115 of the stator windings 114 into the contact elements 30 of the lead frame 10. In particular, making contact 330 may comprise pressing press-in sections 132 into the contact elements 30 or into their opening 32 on the lower side 12b.

In configurations of the method 300, the method 300 may further comprise providing 340 a stator housing 120. The stator housing 120 defines an annular receiving area with a circumferential section 122 and an annular end wall 124.

Furthermore, the method 300 may comprise inserting 350 the stator 110, with which contact has been made, with the lead frame 10 axially arranged thereon, into the receiving area of the stator housing 120. In configurations, the stator 110, with which contact has been made, can first be inserted with the lead frame 10 in the axial direction 2 into the stator housing 120, such that the lead frame 10 is arranged adjacent to the annular end wall 124. In particular, the stator 110, with which contact has been made, can be inserted with the lead frame 10 into the stator housing 120 such that the upper side 12a of the lead frame 10 is arranged adjacent to the annular end wall 124. In configurations, a connection apparatus 50 of the lead frame 10 can be guided at least partially through a passage 126 in the annular end wall 124 to the outside of the stator housing 120 during insertion. This allows an inverter 240 to be electrically connected to the lead frame 10 outside the stator housing 120 via the connection apparatus 50.

In addition, the method 300 may comprise potting 360 the stator 110 with the lead frame 10 in the stator housing 120 by filling potting compound into the receiving area, whereby a potting body 140 is formed between the stator 110, which is in contact with the lead frame 10, and the stator housing 120 after the potting compound has hardened. The potting makes it possible for the stator 110, which is in contact with the lead frame 10, to be fixed in the potting body 140 and thus in the stator housing 120 after the potting compound has hardened.

In configurations of the method 300, a resin material, in particular a synthetic resin material, can be used as the potting compound. In configurations, the potting compound may be provided with fillers promoting heat conduction.

Although the present invention has been described above and defined in the appended claims, it should be understood that the invention may alternatively also be defined in accordance with the following embodiments:
1. Lead frame (10) for making electrical contact with stator windings (114) of a three-phase stator (110), comprising:
   an annular main body (12) with an upper side (12a) and a lower side (12b); three connection contacts (40) for making electrical contact between a respective stator phase (P1, P2, P3) and an inverter (240) on the inverter side;
   a plurality of axially insulated line planes (20) arranged in the annular main body (12), wherein the line planes (20) have a plurality of line sections (22) spaced apart in the circumferential direction (6);
   a plurality of electrically conductive contact elements (30) which extend axially through the annular main body (12) and are arranged so as to be radially spaced apart from the line sections (22), wherein the contact elements (30) are arranged so as to be distributed in the circumferential direction (6);
   wherein the line planes (20) furthermore have line tabs (24) which protrude radially from the line sections (22) and electrically connect the line sections (22) to the contact elements (30), wherein the line tabs (24) are arranged in such a way that an electrical interconnection of the stator phases (P1, P2, P3) between the contact elements (30) and the connection contacts (40) is provided by the line planes (20) and the contact elements (30),
   wherein at least some of the plurality of contact elements (30) are designed to make electrical contact with the stator windings (114).
2. Lead frame (10) according to embodiment 1, wherein the at least some of the plurality of contact elements (30) have an opening (32) on the lower side (12b) for making electrical contact with the stator windings (114), in particular so that the lead frame (10) can be mounted onto electrical ends of the stator (110).
3. Lead frame (10) according to embodiment 2, wherein the at least some of the plurality of contact elements (30) have a passage (34) extending from the opening (32) to the upper side (12a).
4. Lead frame (10) according to embodiment 3, wherein the passage (34) is formed so as to taper toward the upper side (12).
5. Lead frame (10) according to any of embodiments 1 to 4, wherein the at least some of the plurality of contact elements (30) are designed to press in electrical connectors (130) of the stator windings (114) of the stator (110), in particular so that the lead frame (10) can be pressed onto the electrical connectors (130).
6. Lead frame (10) according to any of the preceding embodiments, wherein the at least some of the plurality of contact elements (30) are provided in a number of wire ends (115) present in the stator (110) with which contact is to be made.
7. Lead frame (10) according to any of the preceding embodiments, wherein the at least some of the plurality of contact elements (30) are provided in a number of 6 to 72, in particular 12 to 36.
8. Lead frame (10) according to any of the preceding embodiments, wherein the plurality of contact elements (30) are provided in a number of 6 to 72, in particular 12 to 36.
9. Lead frame (10) according to any of the preceding embodiments, wherein the contact elements (30) are arranged at positions (Sᵢ) which are distributed in the circumferential direction (6) and are assigned to areas of stator windings (112) of a respective stator phase (P1, P2, P3).
10. Lead frame (10) according to embodiment 9, wherein the line tabs (24) are arranged only at those positions (Sᵢ) in a respective line plane (20) which are required for the electrical interconnection of the stator phases (P1, P2, P3) of the line section (22) connected to the line tab (24).
11. Lead frame (10) according to any of the preceding embodiments, wherein the contact elements (30) are arranged radially inside and/or radially outside the line sections (22).
12. Lead frame (10) according to any of the preceding embodiments, wherein the contact elements (30) are arranged so as to be spaced apart from an inner circumference (12c) of the annular main body (12) and/or from an outer circumference (12d) of the annular main body (12).
13. Lead frame (10) according to any of the preceding embodiments, wherein a radial width of the annular main body (12) between an inner diameter of the annular main body (12) and an outer diameter of the annular main body (12) is 20 mm or more, preferably 30 mm or more, and particularly preferably 40 mm or more.
14. Lead frame (10) according to any of the preceding embodiments, wherein the line sections (22) extend at least in sections in the radial direction (4) at least over 40%, preferably at least over 50%, and particularly preferably at least over 60%, of a radial width of the annular main body (12) between an inner diameter of the annular main body (12) and an outer diameter of the annular main body (12).
15. Lead frame (10) according to any of the preceding embodiments, wherein an axial thickness of the line planes (20) is smaller than a radial width of the line planes (20) at least by a factor of 50, preferably at least by a factor of 100, and particularly preferably at least by a factor of 200.
16. Lead frame (10) according to any of the preceding embodiments, wherein an axial thickness of the line planes (20) is 200 μm or less, preferably 150 μm or less, and particularly preferably 125 μm or less.
17. Lead frame (10) according to any of the preceding embodiments, wherein an axial thickness of the annular main body (12) is 1 mm to 3 mm, preferably 1.2 mm to 2 mm, and particularly preferably 1.4 mm to 1.8 mm.
18. Lead frame (10) according to any of the preceding embodiments, wherein the annular main body (12) has a multi-layer printed circuit board structure.
19. Lead frame (10) according to any of the preceding embodiments, wherein the line planes are embedded in a substrate, in particular wherein the line planes are electrically insulated from each other by a substrate.
20. Lead frame (10) according to any of the preceding embodiments, wherein at least three line planes (20), in particular at least six line planes (20), are arranged in the annular main body (12).
21. Lead frame (10) according to any of the preceding embodiments, wherein each line plane (20) has at least two, preferably at least three, and particularly preferably at least four, line sections (22) spaced apart from each other in the circumferential direction (6).
22. Lead frame (10) according to any of the preceding embodiments, wherein the line sections (22) extend in the circumferential direction (6).
23. Lead frame (10) according to any of the preceding embodiments, wherein each line section (22) is connected to at least one line tab (24).
24. Lead frame (10) according to any of the preceding embodiments, wherein the line tabs (24) surround the contact elements (30) in the radial direction (2) and in the circumferential direction (6), in particular completely in the radial direction (2) and in the circumferential direction (6).
25. Lead frame (10) according to any of the preceding embodiments, wherein the line planes (20) are configured such that a star circuit or a delta circuit of the stator phases (P1, P2, P3) is provided.
26. Lead frame (10) according to any of the preceding embodiments, wherein the connection contacts (40) are electrically connected to a line section (22) in at least one line plane (20) directly and/or via at least one conductor pin arrangement.
27. Lead frame (10) according to any of the preceding embodiments, wherein the annular main body (12) comprises a radial bulge on which the connection contacts (40) are arranged.
28. Lead frame (10) according to any of the preceding embodiments, further comprising a connection apparatus (50) which is electrically connected to the connection contacts (40) for the purpose of making electrical contact between a respective stator phase (P1, P2, P3) and the inverter (240).
29. Lead frame (10) according to embodiment 28, wherein the connection apparatus (50) is arranged on the upper side (12a) of the annular main body (12).
30. Lead frame (10) according to any of embodiments 28 and 29, wherein the connection apparatus (50) is fastened to the annular main body (12) in a floating manner.
31. Lead frame (10) according to any of embodiments 28 to 30, wherein the connection apparatus (50) comprises a housing, three main line pins and three cables for electrical connection between the main line pins and the connection contacts (40), wherein the main line pins are fastened in the housing and project in the axial direction (2) from the housing.
32. Stator arrangement (100) for an electrical machine (200), wherein the stator arrangement (100) comprises:
   a stator (110) having a plurality of stator teeth (112) wound with winding wire in order to form a stator winding (114) on a stator tooth (112),
   a lead frame (10) according to any of the preceding embodiments,
   wherein the lead frame (10) is arranged at an axial end of the stator (110) and is electrically connected to electrical ends of the stator (110) for interconnecting the stator phases (P1, P2, P3).
33. Stator arrangement (100) according to embodiment 32, wherein the stator teeth (112) are wound with a winding wire individually or in winding groups of the same stator phase (P1, P2, P3).
34. Stator arrangement (100) according to any of embodiments 32 and 33, further comprising a plurality of electrical connectors (130), wherein a respective wire end (115) of the winding wire is electrically connected to the lead frame (10) via one of the plurality of electrical connectors (130).
35. Stator arrangement (100) according to embodiment 34, wherein the lead frame (10) is plugged, in particular is pressed, onto the electrical connectors (130) for making electrical contact with the stator windings (114).
36. Stator arrangement (100) according to any of embodiments 34 and 35, wherein the electrical connectors (130) have a press-in section (132) which is connected to the contact elements (30).
37. Stator arrangement (100) according to any of embodiments 34 to 36, wherein the electrical connectors (130) are in the form of insulation displacement connectors having an insulation displacement section (134), wherein a respective insulation displacement section (134) is plugged onto a respective wire end (115).
38. Stator arrangement (100) according to any of embodiments 32 to 37, wherein the stator (110) further comprises a plurality of receiving sections (117) which are configured to receive the wire ends (115) and to receive electrical connectors (130).
39. Stator arrangement (100) according to embodiment 38, wherein the receiving sections (117) comprise a respective wire end receiving area (117a) which is configured to receive a respective wire end (115).
40. Stator arrangement (100) according to any of embodiments 38 and 39, wherein the receiving sections (117) comprise a respective connector receiving area (117b) which is configured to receive a respective electrical connector (130).
41. Stator arrangement (100) according to embodiments 39 and 40, wherein the wire end receiving area (117a) and the connector receiving area (117b) are arranged so as to intersect each other, so that, when an electrical connector (130) is inserted into a connector receiving area (117b), a wire end arranged in the wire end receiving area (117a) is cut by the electrical connector (130) with electrical contact.
42. Stator arrangement (100) according to any of embodiments 38 to 41, if at least dependent on embodiment 34, wherein the electrical connectors (130) are each arranged in a receiving section (117) such that a press-in section (132) of an electrical connector (130) projects from the receiving section (117) and is connected to the line arrangement (10).
43. Stator arrangement (100) according to any of embodiments 38 to 42, wherein the receiving sections (117) comprise a respective lead frame receiving area (117c) which is configured to support the lead frame (10).
44. Stator arrangement (100) according to any of embodiments 38 to 43, wherein the receiving sections (117) are integrated in a stator end cap (116) of the stator (110).
45. Stator arrangement (100) according to any of embodiments 32 to 44, further comprising a potting body (140) and a stator housing (120), which defines an annular receiving area with a circumferential section (122) and an annular end wall (124),
   wherein the stator (110) is arranged with the lead frame (10) in the receiving area such that the lead frame (10) is arranged adjacent to the annular end wall (124).
46. Stator arrangement (100) according to embodiment 45, wherein the stator (110) is potted with the lead frame (10) in the receiving area and is at least partially embedded in the potting body (140) by virtue of the potting body (140) arranged between the stator housing (120) and the stator (110) with the lead frame (10).
47. Stator arrangement (100) according to any of embodiments 45 to 46, wherein the stator housing (120) further comprises a passage (126) in the annular end wall (124), wherein a connection apparatus (50) of the lead frame projects at least partially through the passage (126) to the outside of the stator housing (110).
48. Electrical machine (200), in particular electric motor (200), comprising:
   a machine housing (210),
   a shaft (230) which is mounted rotatably in the machine housing (210),
   at least one rotor (220) which is arranged for conjoint rotation on the shaft (230) in the machine housing (210),
   a stator arrangement (100) according to any of embodiments 32 to 47, wherein the stator (110) is arranged adjacent to the rotor (220) in the machine housing (210), and
   an inverter (240) for controlling the stator (110), wherein the inverter (240) is electrically connected to the lead frame (10).
49. Electrical machine (200) according to embodiment 48, wherein the inverter (240) is electrically connected to the lead frame (10) via a connection apparatus (50).
50. Electrical machine (200) according to any of embodiments 48 and 49, wherein the stator (110) is arranged radially adjacent to the rotor (220) in the machine housing (210).
51. Electrical machine (200) according to embodiment 50, wherein the rotor (220) is formed externally and comprises a plurality of rotor poles (222) which are arranged so as to be distributed in the circumferential direction (6) on a rotor body (224) of the rotor (220).
52. Electrical machine (200) according to any of embodiments 48 to 51, wherein the machine housing (210) comprises a rotor housing (212) and a stator housing (120), wherein the rotor housing (212) and the stator housing (120) are connected to each other in a force-fitting manner.
53. Method (300) for producing a stator arrangement (100) for an electrical machine (200), comprising the steps of:
   providing (310) a stator (110) having a plurality of stator teeth (212) wound with stator windings (114) having electrical ends,
   providing (320) a lead frame (10) according to any of embodiments 1 to 31,
   making contact (330) with the stator windings (114) by making contact between electrical ends of the stator windings (114) and the contact elements (30) of the lead frame (10).
54. Method (300) according to embodiment 53, wherein an electrical connector (130) is clamped onto a respective wire end (115) of the stator windings (114) in order to form electrical ends of the stator (110).
55. Method (300) according to embodiment 54, wherein the wire ends (115) of the stator windings (114) are pressed into an insulation displacement section (134) of a respective electrical connector (130).
56. Method (300) according to any of embodiments 53 to 55, wherein the electrical ends are provided by inserting wire ends (115) into a wire end receiving area (117a) of the stator (110) and inserting an electrical connector (130) into a connector receiving area (117b) of the stator (110), wherein an insulation displacement section (134) of the electrical connector (130) makes electrical contact with the respective wire end (115).
57. Method (300) according to any of embodiments 53 to 56, wherein making contact (330) with electrical ends comprises mounting, in particular pressing, the lead frame (10) onto the electrical ends protruding substantially in the axial direction (2) from the stator (110).
58. Method (300) according to any of embodiments 53 to 57, wherein making contact with electrical ends comprises pressing electrical connectors (130) connected to the wire ends (115) of the stator windings (114) into the contact elements (30) of the lead frame (10).
59. Method (300) according to any of embodiments 53 to 58, further comprising:
   providing (340) a stator housing (120) which defines an annular receiving area having a circumferential section (122) and an annular end wall (124),
   inserting (350) the stator (110), with which contact has been made, with the lead frame (10) axially arranged thereon, into the receiving area of the stator housing (120),
   potting (360) the stator (110) with the lead frame (10) in the stator housing (120) by filling potting compound into the receiving area, whereby a potting body (140) is formed between the stator (110), which is in contact with the lead frame (10), and the stator housing (120) after the potting compound has hardened.
60. Method (300) according to embodiment 59, wherein the stator (110), with which contact has been made, is first inserted with the lead frame (10) in the axial direction (2) into the stator housing (120), such that the lead frame (10) is arranged adjacent to the annular end wall (124).
61. Method (300) according to embodiment 60, wherein a connection apparatus (50) of the lead frame (10) is guided at least partially through a passage (126) in the annular end wall (124) to the outside of the stator housing (120) during insertion.
62. Method according to any of embodiments 59 to 61, wherein a resin material, in particular a synthetic resin material, which is optionally provided with fillers promoting heat conduction, is used as the potting compound.

### LIST OF REFERENCE SIGNS

2 Axial direction
4 Radial direction
6 Circumferential direction
10 Lead frame
12 Main body
12a Upper side
12b Lower side
12c Inner circumference
12d Outer circumference
20 Line plane
22 Line section
24 Line tab
30 Contact element
32 Opening
34 Passage
40 Connection contact
50 Connection apparatus
100 Stator arrangement
110 Stator
112 Stator tooth
114 Stator winding
115 Winding end
116 Stator end cap
117 Receiving section
117a Wire end receiving area
117b Connector receiving area
117c Lead frame receiving area
120 Stator housing
122 Circumferential section
124 Annular end wall
126 Inverter passage
130 Connector; insulation displacement connector
132 Press-in section
134 Insulation displacement section
140 Potting body
200 Electrical machine
210 Machine housing
212 Rotor housing
220 Rotor
222 Rotor magnet
224 Rotor body
230 Shaft
240 Inverter

1. A lead frame (10) for making electrical contact with stator windings (114) of a three-phase stator (110), comprising:
an annular main body (12) with an upper side (12a) and a lower side (12b);
three connection contacts (40) for making electrical contact between a respective stator phase (P1, P2, P3) and an inverter (240) on the inverter side;
a plurality of axially insulated line planes (20) arranged in the annular main body (12), wherein the line planes (20) have a plurality of line sections (22) spaced apart in the circumferential direction (6);
a plurality of electrically conductive contact elements (30) which extend axially through the annular main body (12) and are arranged so as to be radially spaced apart from the line sections (22), wherein the contact elements (30) are arranged so as to be distributed in the circumferential direction (6);
wherein the line planes (20) furthermore have line tabs (24) which protrude radially from the line sections (22) and electrically connect the line sections (22) to the contact elements (30), wherein the line tabs (24) are arranged in such a way that an electrical interconnection of the stator phases (P1, P2, P3) between the contact elements (30) and the connection contacts (40) is provided by the line planes (20) and the contact elements (30),
wherein at least some of the plurality of contact elements (30) are designed to make electrical contact with the stator windings (114).

2. The lead frame (10) as claimed in claim 1, wherein the at least some of the plurality of contact elements (30) have an opening (32) on the lower side (12b) for making electrical contact with the stator windings (114), so that the lead frame (10) can be mounted onto electrical ends of the stator (110).

3. The lead frame (10) as claimed in claim 1, wherein the at least some of the plurality of contact elements (30) are designed to press in electrical connectors (130) of the stator windings (114) of the stator (110), so that the lead frame (10) can be pressed onto the electrical connectors (130).

4. The lead frame (10) as claimed in claim 1, wherein the at least some of the plurality of contact elements (30) are provided in a number of wire ends (115) which are present in the stator (110) with which contact is to be made.

5. The lead frame (10) as claimed in claim 1, wherein the contact elements (30) are arranged at least radially inside and radially outside the line sections (22).

6. The lead frame (10) as claimed in claim 1, wherein the line sections (22) extend at least in sections in the radial direction (4) at least over 60% of a radial width of the annular main body (12) between an inner diameter of the annular main body (12) and an outer diameter of the annular main body (12).

7. The lead frame (10) as claimed in claim 1, wherein an axial thickness of the line planes (20) is smaller than a radial width of the line planes (20) at least by a factor of 200.

8. The lead frame (10) as claimed in claim 1, wherein an axial thickness of the line planes (20) is 125 μm or less.

9. The lead frame (10) as claimed in claim 1, wherein each line plane (20) has at least three line sections (22) spaced apart from each other in the circumferential direction (6).

10. The lead frame (10) as claimed in claim 1, further comprising a connection apparatus (50) which is electrically connected to the connection contacts (40) for the purpose of making electrical contact between a respective stator phase (P1, P2, P3) and the inverter (240).

11. The lead frame (10) as claimed in claim 10, wherein the connection apparatus (50) is fastened to the annular main body (12) in a floating manner.

12. A stator arrangement (100) for an electrical machine (200), wherein the stator arrangement (100) comprises:
a stator (110) having a plurality of stator teeth (112) wound with winding wire in order to form a stator winding (114) on a stator tooth (112),
a lead frame (10) as claimed in claim 1,
wherein the lead frame (10) is arranged at an axial end of the stator (110) and is electrically connected to electrical ends of the stator (110) for interconnecting the stator phases (P1, P2, P3).

13. The stator arrangement (100) as claimed in claim 12, further comprising a plurality of electrical connectors (130), wherein a respective wire end (115) of the winding wire is electrically connected to the lead frame (10) via one of the plurality of electrical connectors (130).

14. The stator arrangement (100) as claimed in claim 13, wherein the lead frame (10) is pressed onto the electrical connectors (130) for making electrical contact with the stator windings (114).

15. The stator arrangement (100) as claimed in claim 12, wherein the stator (110) further comprises a plurality of receiving sections (117) which are configured to receive the wire ends (115) and to receive electrical connectors (130).

16. An electrical machine (200) comprising:
a machine housing (210),
a shaft (230) which is mounted rotatably in the machine housing (210),
at least one rotor (220) which is arranged for conjoint rotation on the shaft (230) in the machine housing (210),
a stator arrangement (100) as claimed in claim 12, wherein the stator (110) is arranged adjacent to the rotor (220) in the machine housing (210), and
an inverter (240) for controlling the stator (110), wherein the inverter (240) is electrically connected to the lead frame (10).

17. A method (300) for producing a stator arrangement (100) for an electrical machine (200), comprising the steps of:
providing (310) a stator (110) having a plurality of stator teeth (212) wound with stator windings (114) having electrical ends,
providing (320) a lead frame (10) as claimed in claim 1,
making contact (330) with the stator windings (114) by making contact between electrical ends of the stator windings (114) and the contact elements (30) of the lead frame (10).
